(19) United States
(12) Patent Application Publication
(10) Pub. No.: US 2023/0249348 A1
(43) Pub. Date: Aug. 10, 2023

(54) ROBOT

(71) Applicant: KAWASAKI JUKOGYO KABUSHIKI KAISHA, Kobe-shi, Hyogo (JP)

(72) Inventors: Kazunori HIRATA, Kobe-shi (JP); Keita SASAKI, Kobe-shi (JP)

(73) Assignee: KAWASAKI JUKOGYO KABUSHIKI KAISHA, Kobe-shi, Hyogo (JP)

(21) Appl. No.: 18/013,363

(22) PCT Filed: Jun. 29, 2021
(86) PCT No.: PCT/JP2021/024596

§ 371 Date: Dec. 28, 2022

(30) Foreign Application Priority Data
Jun. 29, 2020 (JP) 2020-112045

(51) Int. Cl. B25J 9/16; B25J 15/00; B25J 18/00

(52) U.S. Cl. CPC B25J 9/1679; B25J 15/0004; B25J 18/007

(57) ABSTRACT

A controller of a robot turns over a workpiece into a second state by causing a first end effector to execute a holding operation of holding a first portion in a first state, causing the first robot arm to execute, after the holding operation, a lifting operation of lifting the first end effector such that a second sheet surface separates from a turnover station, causing the first robot arm to execute, after the lifting operation, a lowering operation of lowering the first end effector with a first sheet surface facing downward, and causing the first end effector to execute, before completion of the lowering operation and after the holding operation, a rotary operation of rotating about a first rotation axis in a direction of raising a first end portion.

### FIELD

The technique disclosed herein relates to a robot.

### BACKGROUND

Typically, a robot that performs a process of turning over a workpiece has been known For example, Patent Document 1 discloses a robot including two arms A hand portion is located at a tip end of each arm. The robot sandwiches, with two hand portions, a workpiece from both sides in a predetermined rotation axis direction, and rotates these two hand portions about a rotation axis. In this manner, the workpiece is turned over

### CITATION LIST

### Patent Document

Patent Document 1: Japanese Unexamined Patent Application Publication No. 2018-1352

### SUMMARY OF THE INVENTION

There are various workpieces, and for example, there are sheet-shaped workpieces having flexibility. In the case of the workpiece having the flexibility, it is sometimes difficult to turn over the workpiece as in a workpiece having stiffness. For example, in the case of the workpiece having the flexibility, it is difficult to sandwich, with two hand portions, the workpiece from both sides in the rotation axis direction to turn over the workpiece about the rotation axis.

The technique disclosed herein has been made in view of the above-described point, and an object thereof is to turn over a workpiece having flexibility by simple operation.

The robot disclosed herein is a robot that turns over a sheet-shaped workpiece, which is mounted on a base in a first state in which a first sheet surface faces upward and a second sheet surface faces downward and has flexibility, such that arrangement of a first end portion positioned on a first side in a predetermined turnover direction and a second end portion positioned on a second side in the turnover direction is reversed to bring the workpiece into a second state in which the first sheet surface faces downward and the second sheet surface faces upward The robot includes a first robot arm, a first end effector that is coupled to the first robot arm so as to rotate about a predetermined first rotation axis, and a controller that controls the first robot arm and the first end effector. The controller turns over the workpiece into the second state by causing the first end effector to execute a holding operation of holding a first portion, which is a portion including the first end portion when the workpiece is divided in half in the turnover direction, of the workpiece in the first state with the first rotation axis being parallel with the first sheet surface and the second sheet surface, causing the first robot arm to execute, after the holding operation, a lifting operation of lifting the first end effector such that the second sheet surface separates from the base, causing the first robot arm to execute, after the lifting operation, a lowering operation of lowering the first end effector with the first sheet surface facing downward, and causing the first end effector to execute, before completion of the lowering operation and after the holding operation, a rotary operation of rotating about the first rotation axis in a direction of raising the first end portion.

According to the above-described robot, the workpiece having the flexibility can be turned over by the simple operation.

### BRIEF DESCRIPTION OF THE DRAWINGS

FIG. 1 is a front view of a double-arm robot.

FIG. 2 is a plan view of the double-arm robot.

FIG. 3 is a left side view of the double-arm robot.

FIG. 4 is a right side view of the double-arm robot.

FIG. 5 is a perspective view of a first end effector and a second end effector.

FIG. 6 is a block diagram of a controller.

FIG. 7 is a plan view showing one example of a workpiece.

FIG. 8 is a plan view of the double-arm robot in holding operation.

FIG. 9 is a schematic view showing, from the front of the double-arm robot, the states of the workpiece and the first end effector in the holding operation.

FIG. 10 is a schematic view showing, from the front of the robot, the states of the workpiece and the first end effector upon completion of lifting operation.

FIG. 11 is a schematic view showing, from the front of the robot, the states of the workpiece and the first end effector in preliminary operation.

FIG. 12 is a schematic view showing, from the front of the robot, the states of the workpiece and the first end effector in a first phase of lowering operation.

FIG. 13 is a plan view of the double-arm robot in a final phase of the lowering operation.

FIG. 14 is a schematic view showing, from the front of the robot, the states of the workpiece and the first end effector upon completion of the lowering operation.

FIG. 15 is a schematic view showing, from the front of the double-arm robot, the states of the workpiece, the first end effector, and the second end effector upon completion of release operation.

FIG. 16 is a plan view of a jig plate.

FIG. 17 is a plan view of the double-arm robot in delivery operation.

FIG. 18 is a schematic view showing, in a width direction of the workpiece, the states of the workpiece and the second end effector in separating operation.

FIG. 19 is a perspective view of a pushout tool.

FIG. 20 is a schematic view showing, in the width direction of the workpiece, the states of the workpiece, the first end effector, and the second end effector in pushout operation.

FIG. 21 is a schematic view showing, in the width direction of the workpiece, the states of the workpiece, the first end effector, and the second end effector in insertion operation.

FIG. 22 is a plan view of the workpiece placed on the jig plate

FIG. 23 is a schematic view showing, from the front of a double-arm robot, the states of a workpiece and a first end effector in a first phase of lifting operation in a turnover process according to a variation.

FIG. 24 is a schematic view showing, from the front of the double-arm robot, the states of the workpiece and the first end effector in a final phase of the lifting operation

FIG. 25 is a schematic view showing, from the front of the double-arm robot, the states of the workpiece and the first end effector upon completion of the lifting operation.

FIG. 26 is a schematic view showing, from the front of the double-arm robot, the states of the workpiece, the first end effector, and a second end effector upon completion of lowering operation.

### DESCRIPTION OF EMBODIMENTS

Hereinafter, an exemplary embodiment will be described in detail with reference to the drawings.

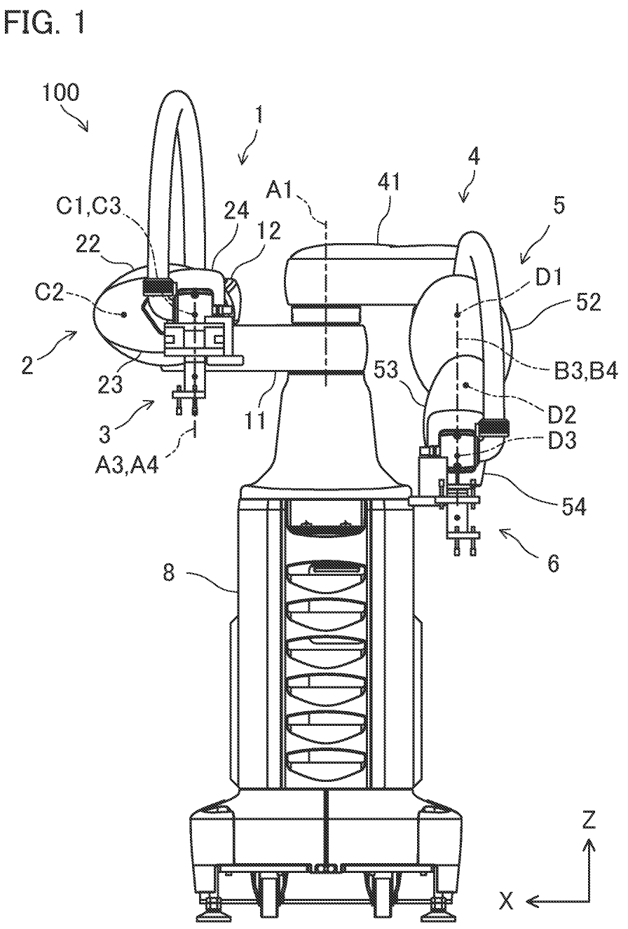

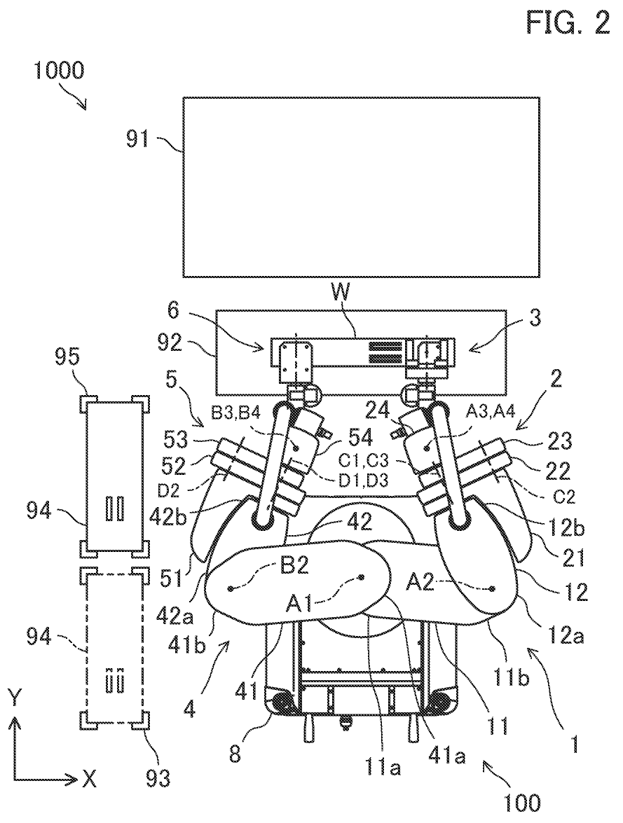

A double-arm robot 100 according to the embodiment will be described. FIG. 1 is a front view of the double-arm robot 100. FIG. 2 is a plan view of the double-arm robot 100. Note that FIG. 2 shows a state in which the double-arm robot 100 is incorporated into a work system 1000

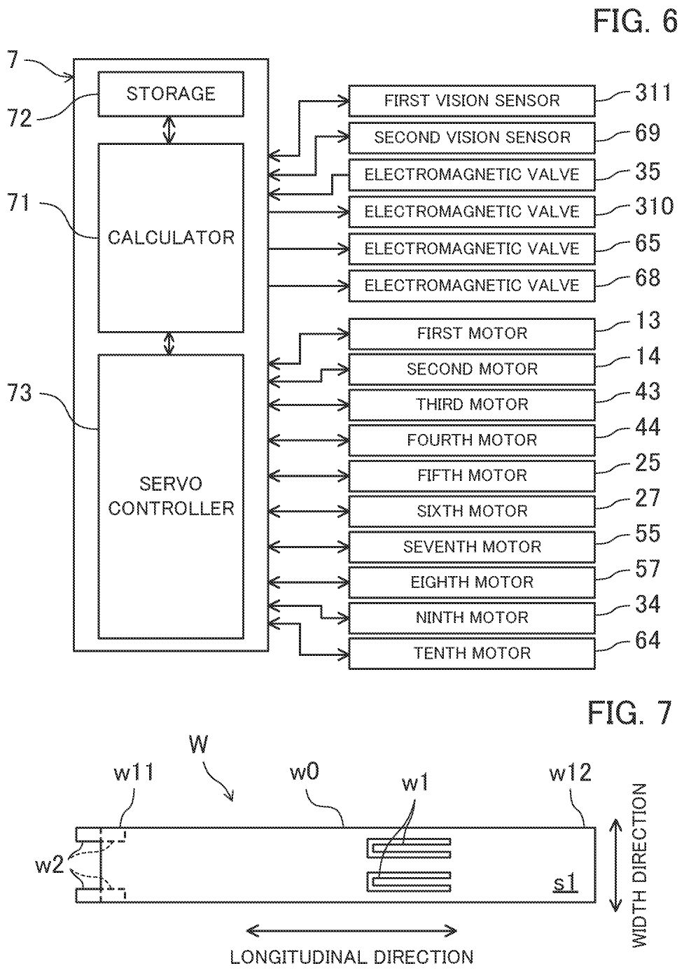

The double-arm robot (hereinafter also merely referred to as a robot) 100 includes a first robot arm 1, a first end effector 3 coupled to the first robot arm 1, a second robot arm 4, a second end effector 6 coupled to the second robot arm 4, and a controller 7 (see FIG. 6)

### Robot Arm

The first robot arm 1 and the second robot arm 4 are articulated robot arms More specifically, the first robot arm 1 and the second robot arm 4 are horizontal articulated robot arms. The first robot arm 1 and the second robot arm 4 executes collaborative operation.

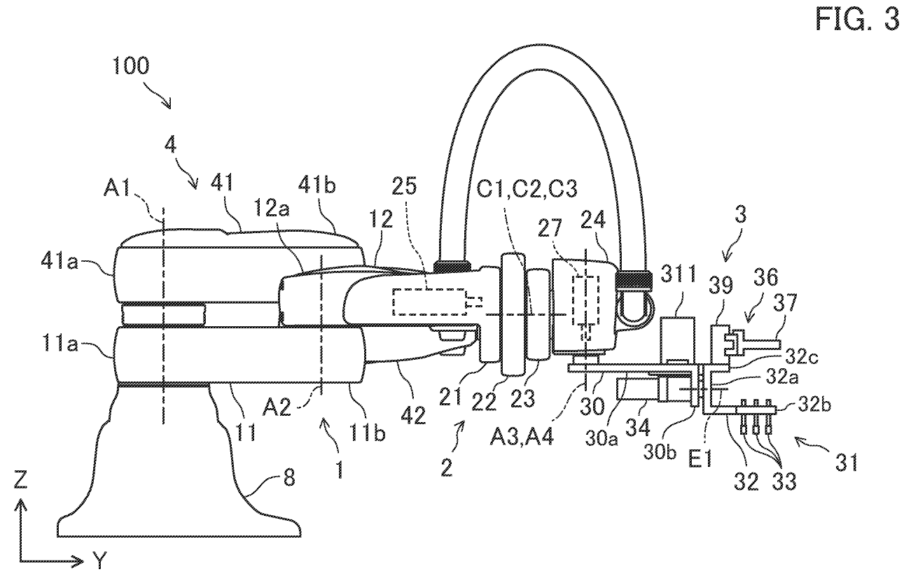

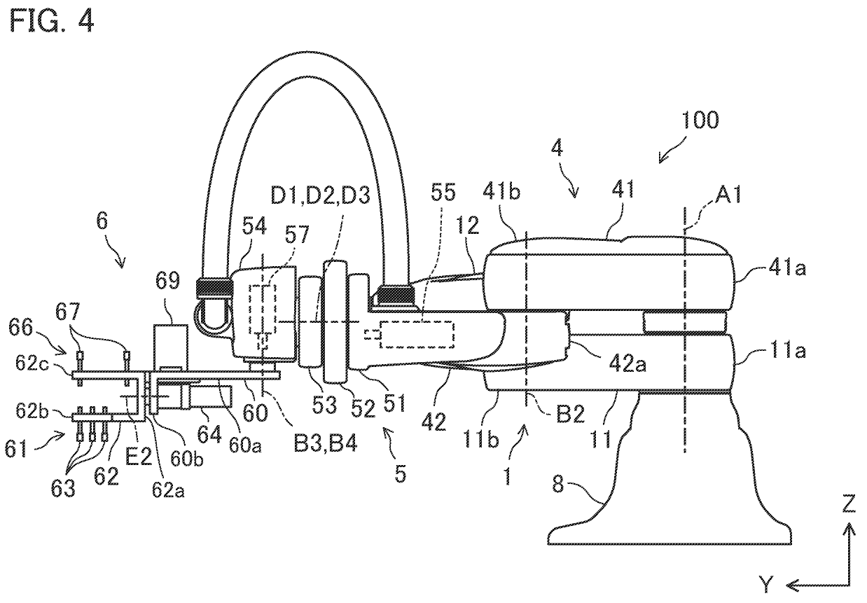

Hereinafter, X-, Y-, and Z-axes perpendicular to each other are set for the sake of convenience in description The Z-axis extends in an up-down direction FIG. 3 is a left side view of the double-arm robot 100. FIG. 4 is a right side view of the double-arm robot 100. Note that part of a mount 8 is not shown in FIGS. 3 and 4. The states of the first robot arm 1 and the second robot arm 4 are different among FIGS. 1 to 4. The states of a first wrist 2 and a second wrist 5 are different between FIGS. 1 and 2.

The first robot arm 1 has a first link 11, a second link 12, and the first wrist 2. The second robot arm 4 has a first link 41, a second link 42, and the second wrist 5. Hereinafter, one end portion of each link in a longitudinal direction thereof will be referred to as a first end portion, and an end portion opposite to the first end portion in the longitudinal direction will be referred to as a second end portion.

Of the first robot arm 1, a first end portion 11a of the first link 11 is coupled to the mount 8 so as to rotate about a first axis A1 extending in the Z-axis direction. A first end portion 12a of the second link 12 is coupled to a second end portion 11b of the first link 11 so as to rotate about a second axis A2 extending in the Z-axis direction. The first end portion 12a of the second link 12 is disposed above the second end portion 11b of the first link 11.

Of the second robot arm 4, a first end portion 41a of the first link 41 is coupled to the mount 8 so as to rotate about the first axis A1 That is, the first link 41 is coupled to the mount 8 coaxially with the first link 11. The first end portion 41a of the first link 41 is disposed above the first end portion 11a of the first link 11. A first end portion 42a of the second link 42 is coupled to a second end portion 41b of the first link 41 so as to rotate about a second axis B2 extending in the Z-axis direction. The first end portion 42a of the second link 42 is disposed below the second end portion 41b of the first link 41.

The robot 100 has a first motor 13 that drives the first link 11, a second motor 14 that drives the second link 12, a third motor 43 that drives the first link 41, and a fourth motor 44 that drives the second link 42 (see FIG. 6) For example, the first motor 13, the second motor 14, the third motor 43, and the fourth motor 44 are servomotors. The servomotor includes an encoder that detects a rotation position of the motor. Although not shown in the figure, the robot 100 has a transmitter that transmits drive force of each motor to the corresponding link. For example, the transmitter is a combination of a gear train, a pulley, and a belt

The first end effector 3 is coupled to a tip end portion of the first robot arm 1, specifically the first wrist 2. The first wrist 2 causes the first end effector 3 to linearly move along a third axis A3 extending in the Z-axis direction, and causes the first end effector 3 to rotate about a fourth axis A4 extending in the Z-axis direction. In this example, the third axis A3 and the fourth axis A4 are the same axis.

The second end effector 6 is coupled to a tip end portion of the second robot arm 4, specifically the second wrist 5. The second wrist 5 causes the second end effector 6 to linearly move along a third axis B3 extending in the Z-axis direction, and causes the second end effector 6 to rotate about a fourth axis B4 extending in the Z-axis direction. In this example, the third axis B3 and the fourth axis B4 are the same axis

### First Wrist

The first wrist 2 has a first connector 21, a first link 22, a second link 23, and a second connector 24. The first connector 21 is attached to a second end portion 12b of the second link 12 in a fixed manner. The first link 22 is coupled to the first connector 21 so as to rotate about a first interlocking axis C1 extending parallel with an XY plane. The second link 23 is coupled to the first link 22 so as to rotate about a second interlocking axis C2 parallel with the first interlocking axis C1. The second connector 24 is coupled to the second link 23 so as to rotate about a third interlocking axis C3 parallel with the first interlocking axis C1.

As shown in FIG. 3, the first connector 21 includes a fifth motor 25. The first wrist 2 includes a transmitter (not shown) that transmits drive force of the fifth motor 25 to each of the first link 22, the second link 23, and the second connector 24. For example, the transmitter is a gear train. The first link 22, the second link 23, and the second connector 24 operate in an interlocking manner by the drive force of the single fifth motor 25 The transmitter rotates the first link 22, the second link 23, and the second connector 24 such that the rotation angles of the first link 22, the second link 23, and the second connector 24 are maintained in a certain relationship. Specifically, the first link 22, the second link 23, and the second connector 24 rotate in an interlocking manner such that the second connector 24 moves only in the direction of the third axis A3 extending in the Z-axis direction while maintaining the posture thereof That is, the first wrist 2 causes the second connector 24 to substantially linearly move along the third axis A3.

The first end effector 3 rotatable about the fourth axis A4 extending in the Z-axis direction is coupled to the second connector 24. The second connector 24 includes a sixth motor 27 and a transmitter (not shown) that transmits drive force of the sixth motor 27 to the first end effector 3. The first end effector 3 is rotated about the fourth axis A4 by the sixth motor 27.

### Second Wrist

The second wrist 5 has a configuration substantially similar to that of the first wrist 2. The second wrist 5 has a first connector 51, a first link 52, a second link 53, and a second connector 54. The first connector 51 corresponds to the first connector 21, the first link 52 corresponds to the first link 22, the second link 53 corresponds to the second link 23, and the second connector 54 corresponds to the second connector 24.

The first connector 51 is attached to a second end portion 42b of the second link 42 in a fixed manner. The first link 52 is coupled to the first connector 51 so as to rotate about a first interlocking axis D1 extending parallel with the XY plane. The second link 53 is coupled to the first link 52 so as to rotate about a second interlocking axis D2 parallel with the first interlocking axis D1. The second connector 54 is coupled to the second link 53 so as to rotate about a third interlocking axis D3 parallel with the first interlocking axis D1.

As shown in FIG. 4, the first connector 51 includes a seventh motor 55 The second wrist 5 includes a transmitter (not shown) that transmits drive force of the seventh motor 55 to each of the first link 52, the second link 53, and the second connector 54. The first link 52, the second link 53, and the second connector 54 operate in an interlocking manner by the drive force of the single seventh motor 55. The transmitter rotates the first link 52, the second link 53, and the second connector 54 such that the rotation angles of the first link 52, the second link 53, and the second connector 54 are maintained in a certain relationship. Specifically, the first link 52, the second link 53, and the second connector 54 rotate in an interlocking manner such that the second connector 54 moves only in the direction of the third axis B3 extending in the Z-axis direction while maintaining the posture thereof. That is, the second wrist 5 causes the second connector 54 to substantially linearly move along the third axis B3.

The second end effector 6 rotatable about the fourth axis B4 extending in the Z-axis direction is coupled to the second connector 54. The second connector 54 includes an eighth motor 57 and a transmitter (not shown) that transmits drive force of the eighth motor 57 to the second end effector 6. The second end effector 6 is rotated about the fourth axis B4 by the eighth motor 57.

### First End Effector

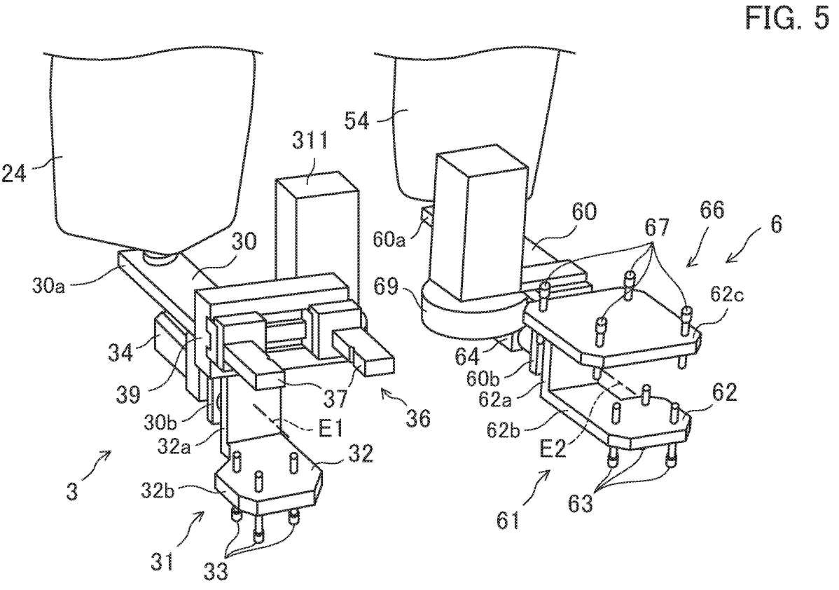

FIG. 5 is a perspective view of the first end effector 3 and the second end effector 6. As shown in FIGS. 3 and 5, the first end effector 3 has a base 30 rotatably coupled to the second connector 24 of the first wrist 2, a sucker 31 located at the base 30, and a hand 36 located at the base 30.

The base 30 has a first plate 30a and a second plate 30b. The first plate 30a and the second plate 30b are coupled perpendicularly to each other. The first plate 30a is coupled to the second connector 24 so as to rotate about the fourth axis A4. The first plate 30a extends in a plane perpendicular to the fourth axis A4, i.e., the horizontal plane. The second plate 30b extends parallel with the fourth axis A4.

The sucker 31 has a bracket 32 and a plurality (e.g., three) of suction pads 33.

The bracket 32 is coupled to the base 30 so as to rotate about a first rotation axis E1 extending in the horizontal direction The bracket 32 has a first plate 32a, a second plate 32b, and a third plate 32c. The first plate 32a, the second plate 32b, and the third plate 32c are coupled perpendicularly to each other The first plate 32a is coupled to the base 30, specifically the second plate 30b, perpendicularly to the first rotation axis E1 The second plate 32b and the third plate 32c extend parallel with the first rotation axis E1.

The base 30 includes a ninth motor 34 that rotates the bracket 32. The bracket 32 is driven so as to rotate about the first rotation axis E1 by the ninth motor 34.

The suction pads 33 are located at the second plate 32b. The suction pads 33 are on a surface of the second plate 32b opposite to the first rotation axis E1. A distance from the second plate 32b to the suction pad 33 is equal among the suction pads 33.

The suction pads 33 are connected to a negative pressure source (not shown) through a pipe and an electromagnetic valve 35 (see FIG. 6). The negative pressure source sucks air, thereby generating suction force at the suction pads 33. The pipe is switched between an open state and a closed state by the electromagnetic valve 35, and as a result, the suction pads 33 are switched between a suction state and a release state.

The hand 36 has a pair of fingers 37 and an actuator (not shown) that drives the pair of fingers 37. The pair of fingers 37 extends parallel with each other and parallel with the first rotation axis E1. The pair of fingers 37 is supported by a guide 39 so as to slide in an approaching or separating direction. The pair of fingers 37 is guided by the guide 39 so as to separate from or approach each other while maintaining the parallel state thereof.

The actuator is, for example, an air cylinder. The actuator is connected to an air compressor (not shown) through a pipe and an electromagnetic valve 310 (see FIG. 6). The air compressor pressure-feeds air, thereby driving the actuator. A direction of moving the pair of fingers 37 by the actuator is switched by the electromagnetic valve 310. That is, the electromagnetic valve 310 switches whether the pair of fingers 37 moves in the separating direction or the approaching direction.

The first end effector 3 further has a first vision sensor 311. The first vision sensor 311 is located at the base 30. The first vision sensor 311 is placed so as to face downward in the Z-axis direction, and images a target below the first vision sensor 311

The first end effector 3 configured in this manner can hold a workpiece by the sucker 31 to rotate the held workpiece about the first rotation axis E1. Moreover, the first end effector 3 can hold another tool by the hand 36 to perform a process with the tool. In this case, the first end effector 3 can also rotate the tool about the first rotation axis E1.

### Second End Effector

As shown in FIGS. 4 and 5, the second end effector 6 has a base 60 rotatably coupled to the second connector 54 of the second wrist 5, a first sucker 61 located at the base 60, and a second sucker 66 located at the base 60.

The base 60 has a first plate 60a and a second plate 60b. The first plate 60a and the second plate 60b are coupled perpendicularly to each other. The first plate 60a is coupled to the second connector 54 so as to rotate about the fourth axis B4. The first plate 60a extends in a plane perpendicular to the fourth axis B4, i.e., the horizontal plane. The second plate 60b extends parallel with the fourth axis B4.

The first sucker 61 has a bracket 62 and a plurality (e.g., three) of first suction pads 63.

The bracket 62 is coupled to the base 60 so as to rotate about a second rotation axis E2 extending in the horizontal direction. The bracket 62 has a first plate 62a, a second plate 62b, and a third plate 62c. The second plate 62b and the third plate 62c are disposed parallel with each other. The first plate 62a, the second plate 62b, and the third plate 62c are coupled perpendicularly to each other. The first plate 62a is coupled to the base 60, specifically the second plate 60b, perpendicularly to the second rotation axis E2. The second plate 62b and the third plate 62c extend parallel with the second rotation axis E2.

The base 60 includes a tenth motor 64 that rotates the bracket 62. The bracket 62 is driven so as to rotate about the second rotation axis E2 by the tenth motor 64.

The first suction pads 63 are located at the second plate 62b. The first suction pads 63 are on a surface of the second plate 62b opposite to the second rotation axis E2. A distance from the second plate 62b to a tip end of the first suction pad 63 is equal among the first suction pads 63.

The first suction pads 63 are connected to a negative pressure source (not shown) through a pipe and an electromagnetic valve 65 (see FIG. 6) The negative pressure source sucks air, thereby generating suction force at the first suction pads 63. The pipe is switched between an open state and a closed state by the electromagnetic valve 65, and as a result, the first suction pads 63 are switched between a suction state and a release state.

The second sucker 66 has the bracket 62 and a plurality (e.g., four) of second suction pads 67. That is, the bracket 62 is shared by the first sucker 61 and the second sucker 66.

The second suction pads 67 are located at the third plate 62c. The second suction pads 67 are on a surface of the third plate 62c opposite to the second rotation axis E2. That is, the first suction pads 63 and the second suction pads 67 face the opposite directions with respect to the second rotation axis E2. A distance from the third plate 62c to a tip end of the second suction pad 67 is equal among the second suction pads 67.

The second suction pads 67 are connected to a negative pressure source (not shown) through a pipe and an electromagnetic valve 68 (see FIG. 6). The negative pressure source sucks air, thereby generating suction force at the second suction pads 67. The pipe is switched between an open state and a closed state by the electromagnetic valve 68, and as a result, the second suction pads 67 are switched between a suction state and a release state.

The second end effector 6 further has a second vision sensor 69. The second vision sensor 69 is located at the base 60. The second vision sensor 69 is placed so as to face downward in the Z-axis direction, and images a target below the second vision sensor 69.

The second end effector 6 configured in this manner can rotate the first sucker 61 and the second sucker 66 about the second rotation axis E2, thereby switching the sucker to be used. Moreover, the second end effector 6 can rotate a workpiece held by the first sucker 61 or the second sucker 66 about the second rotation axis E2.

### Controller

FIG. 6 is a block diagram of the controller 7. The controller 7 has a calculator 71, a storage 72, and a servo controller 73. The calculator 71 includes a processor such as a CPU. The storage 72 includes a ROM, a RAM, etc. The servo controller 73 includes a processor such as a CPU.

The storage 72 stores information such as a basic program and various types of data for a robot controller. The calculator 71 reads and executes software, such as the basic program, stored in the storage 72, thereby controlling various types of operation of the robot 100.

The calculator 71 outputs a control signal to the first vision sensor 311 and the second vision sensor 69. Output signals from the first vision sensor 311 and the second vision sensor 69 are input to the calculator 71. The calculator 71 causes the first vision sensor 311 and the second vision sensor 69 to image the targets, and calculates the positions and shapes of the targets based on imaging results Moreover, the calculator 71 outputs a control signal to the electromagnetic valve 35, the electromagnetic valve 310, the electromagnetic valve 65, and the electromagnetic valve 68. For example, the calculator 71 controls, e.g., the sucker 31 between the suction state and the release state, or controls the pair of fingers 37 of the hand 36 between a separating state and an approaching state. Further, the calculator 71 generates a control command for the robot 100, and outputs the control command to the servo controller 73. For example, the calculator 71 controls the first robot arm 1 and the second robot arm 4 via the servo controller 73.

The servo controller 73 supplies a drive current to each of the first motor 13, the second motor 14, the third motor 43, the fourth motor 44, the fifth motor 25, the sixth motor 27, the seventh motor 55, the eighth motor 57, the ninth motor 34, and the tenth motor 64, and receives a detection signal from the encoder of each motor. For example, the servo controller 73 outputs the drive current to the corresponding motor based on the control command from the calculator 71. In this case, the servo controller 73 controls the drive current based on the detection signal of the encoder.

### Operation of Robot

Subsequently, the work system 1000 into which the robot 100 is incorporated will be described

In the work system 1000, a bending process is performed for a workpiece W, the workpiece W subjected to the bending process is turned over, and the turned-over workpiece W is placed on a jig plate 94 for a next step. The workpiece W is a flexible printed circuit (FPC: a flexible printed circuit board). The FPC is one example of a sheet-shaped workpiece having flexibility.

As shown in FIG. 2, the work system 1000 includes the robot 100, a bending device 91, a turnover station 92, and an installation station 93. The robot 100 executes an extraction process of taking out the workpiece W subjected to the bending process from the bending device 91 and delivering the workpiece W to the turnover station 92. Next, the robot 100 executes a turnover process of turning over the workpiece W on the turnover station 92 Subsequently, the robot 100 executes an installation process of delivering the turned-over workpiece W to the installation station 93 and placing the workpiece W on the jig plate 94. A plate storage 95 in which a plurality of jig plates 94 are stacked on each other is disposed in the vicinity of the installation station 93. The turnover station 92 is one example of a base. The jig plate 94 is one example of a jig.

FIG. 7 is a plan view showing one example of the workpiece W. The workpiece W has a workpiece body w0 in a shape elongated in a predetermined longitudinal direction, such as a strip shape, first protruding pieces w1 located at the workpiece body w0, and second protruding pieces w2 located at the workpiece body w0. One end portion of the workpiece body w0 (i.e, the workpiece W) in the longitudinal direction thereof will be referred to as a first end portion w11, and the other end portion will be referred to as a second end portion w12. Unless otherwise specified, a “longitudinal direction” hereinafter means the longitudinal direction of the workpiece body w0 and the workpiece W, and a “width direction” hereinafter means the width direction of the workpiece body w0 and the workpiece W

Two first protruding pieces w1 are at an intermediate portion of the workpiece body w0 in the longitudinal direction. Note that the intermediate portion in the longitudinal direction does not mean only the center in the longitudinal direction, but means a portion other than both end portions in the longitudinal direction. The first protruding piece w1 is coupled to the workpiece body w0 in a cantilever manner, and extends in the longitudinal direction. Of end portions of the first protruding piece w1 in the longitudinal direction, the end portion closer to the first end portion w11 is a free end. Two first protruding pieces w1 are aligned in the width direction.

Two second protruding pieces w2 are at the first end portion w11.

In a state before the process in the work system 1000, the first protruding pieces w1 and the second protruding pieces w2 are not bent or curved from the workpiece body w0. The second protruding pieces w2 are, by the bending process, bent so as to overlap with the workpiece body w0, as indicated by dashed lines.

Two surfaces of the workpiece W parallel with the longitudinal direction and the width direction will be each referred to as a first sheet surface s1 and a second sheet surface s2

The bending device 91 performs, for the workpiece W, a bending process of bending the second protruding pieces w2. The workpiece W subjected to the bending process is mounted in the bending device 91 with the first sheet surface s1 facing upward.

### Extraction Process

In the extraction process, the robot 100 takes out the workpiece W subjected to the bending process from the bending device 91. The controller 7 causes the first robot arm 1, the first end effector 3, the second robot arm 4, and the second end effector 6 to execute the extraction process. In the extraction process, the first end effector 3 faces the sucker 31 downward, and the second end effector 6 faces the first sucker 61 downward. The first robot arm 1 and the second robot arm 4 cause the first vision sensor 311 and the second vision sensor 69 to move to above the first end portion w11 and the second end portion w12 of the workpiece W. The first vision sensor 311 and the second vision sensor 69 image the workpiece W, and the controller 7 acquires the position and shape of the workpiece W. Based on the acquired position and shape of the workpiece W, the first robot arm 1 and the second robot arm 4 cause the sucker 31 and the first sucker 61 to move to predetermined suction portions of the workpiece W. The sucker 31 and the first sucker 61 suck the workpiece W, thereby holding the workpiece W. The first robot arm 1 and the second robot arm 4 deliver the workpiece W to the turnover station 92. The sucker 31 and the first sucker 61 release the sucked workpiece W onto the turnover station 92. Accordingly, the workpiece W is mounted on the turnover station 92 with the first sheet surface s1 facing upward.

Hereinafter, a state in which the first sheet surface s1 faces upward and the second sheet surface s2 faces downward will be referred to as a first state, and a state in which the first sheet surface s1 faces downward and the second sheet surface s2 faces upward will be referred to as a second state. That is, upon completion of the extraction process, the workpiece W is mounted in the first state on the turnover station 92.

FIG. 2 shows a state after completion of the extraction process. The workpiece W is mounted on the turnover station 92 with the longitudinal direction being coincident with the X-direction. In this state, no jig plate 94 is mounted on the installation station 93. The plurality of jig plates 94 is stacked on each other in the plate storage 95.

### Turnover Process

Subsequently, the robot 100 executes a turnover process of turning over the workpiece W. The robot 100 turns over the workpiece W in a predetermined turnover direction. The phrase “turning over in the turnover direction” as described herein means that the workpiece W is turned over such that arrangement of two end portions of the workpiece W in the turnover direction is reversed. In this example, the longitudinal direction of the workpiece W is coincident with the turnover direction. That is, the workpiece W is turned over such that arrangement of the first end portion w11 and the second end portion w12 of the workpiece W in the longitudinal direction is reversed. In the turnover direction, the side of the workpiece W closer to the first end portion w11 before turnover will be referred to as a “first side in the turnover direction,” and the side of the workpiece W closer to the second end portion w12 before turnover will be referred to as a “second side in the turnover direction.” Moreover, the phrase “arrangement of the first end portion w11 and the second end portion w12 is reversed” means that the side on which the first end portion w11 is disposed with respect to the second end portion w12 in the turnover direction is switched, and does not mean that the position of the first end portion w11 after arrangement reversal is coincident with the position of the second end portion w12 before arrangement reversal.

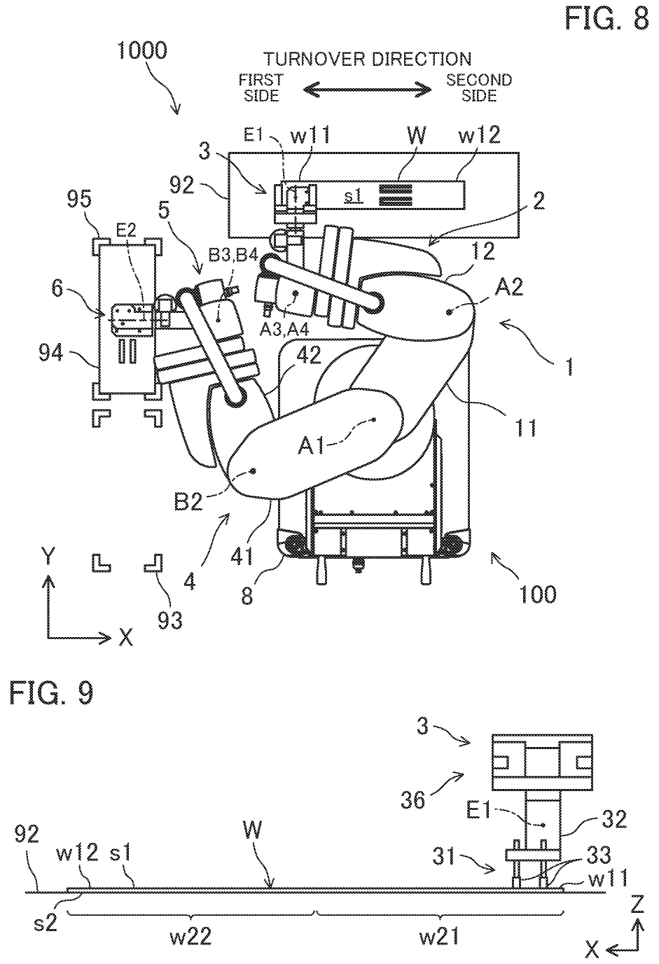

The controller 7 causes the first end effector 3 to execute a holding operation of holding the workpiece W. FIG. 8 is a plan view of the robot 100 in the holding operation. FIG. 9 is a schematic view showing, from the front of the robot 100, the states of the workpiece W and the first end effector 3 in the holding operation. Note that the bending device 91 is not shown in FIG. 8. The same also applies to plan views below.

In the holding operation, the first end effector 3 holds the workpiece W in the first state with the first rotation axis E1 being parallel with the first sheet surface s1 and the second sheet surface s2. Specifically, the first end effector 3 holds a first portion w21 which is a portion including the first end portion w11 when the workpiece W is divided in half in the turnover direction (i.e., the longitudinal direction). Note that a portion opposite to the first portion w21, i.e., the remaining half including the second end portion w12, will be referred to as a second portion w22. The first end effector 3 holds the first portion w21 with the first rotation axis E1 being parallel with the width direction of the workpiece W.

First, the first robot arm 1 moves the first vision sensor 311 to above the first end portion w11 of the workpiece W. The first vision sensor 311 images the first end portion w11 of the workpiece W, and the controller 7 acquires the position and shape of the first end portion w11. The controller 7 controls the first robot arm 1 and the first end effector 3 based on the acquired position and shape of the first end portion w11.

The first robot arm 1 moves the first end effector 3, specifically the sucker 31, to the first end portion w11. At this point, the sucker 31 faces downward. The sucker 31 sucks the first sheet surface s1 of the workpiece W Accordingly, the first end effector 3 sucks and holds the first end portion w11, i.e., the first portion w21.

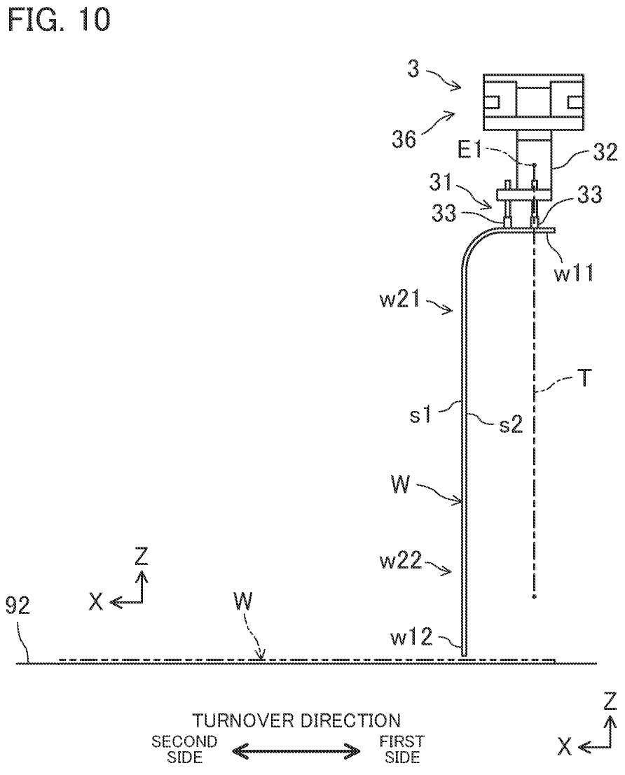

Subsequently, the controller 7 causes the first robot arm 1 to execute lifting operation. FIG. 10 is a schematic view showing, from the front of the robot 100, the states of the workpiece W and the first end effector 3 upon completion of the lifting operation. A chain line in the figure is the trajectory T of the first rotation axis E1 of the first end effector 3. The same also applies to the drawings below

In the lifting operation, the first robot arm 1 lifts the first end effector 3 such that the second sheet surface s2 separates from the turnover station 92. At this point, the first end effector 3 moves in a plane (i.e., a ZX plane) perpendicular to the first rotation axis E1. Note that in each type of later-described operation in the turnover process, the first end effector 3 also moves in the plane perpendicular to the first rotation axis E1.

Specifically, the first robot arm 1 lifts the first end effector 3 substantially in the vertical direction from a position at which the first end effector 3 holds the workpiece W. Lifting of the first end effector 3 is continued until the substantially entirety of the second sheet surface s2 separates from the turnover station 92. In association with such lifting, the second end portion w12 moves to the first side in the turnover direction.

At this point, the first end effector 3 maintains the posture thereof in the holding operation. That is, the sucker 31 faces downward. A portion (hereinafter referred to as a “held portion”) of the workpiece W held by the first end effector 3 is substantially in the horizontal state. The workpiece W hangs from the first end effector 3 with the first sheet surface s1 facing the second side in the turnover direction.

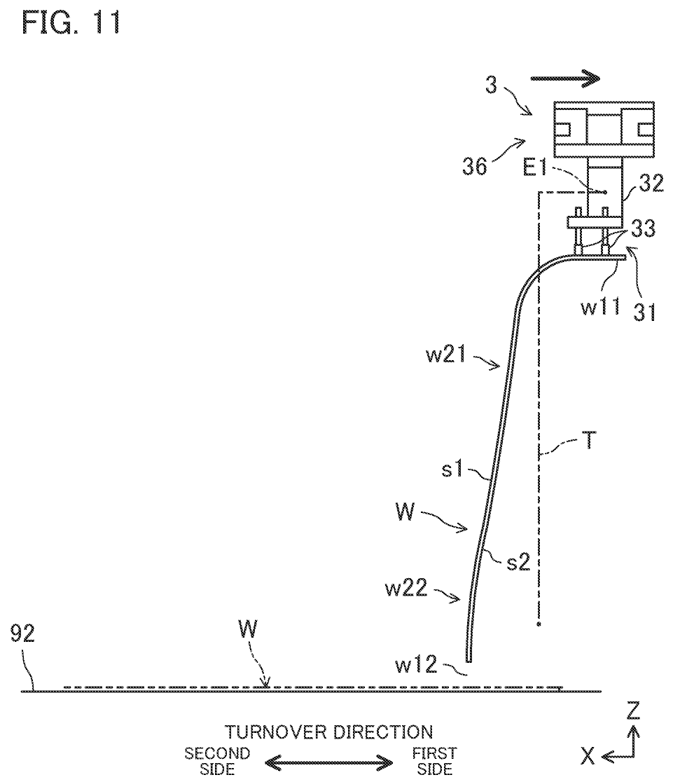

Subsequently, the controller 7 causes the first robot arm 1 to execute preliminary operation. FIG. 11 is a schematic view showing, from the front of the robot 100, the states of the workpiece W and the first end effector 3 in the preliminary operation.

In the preliminary operation, the first robot arm 1 moves the first end effector 3 to the first side in the turnover direction by a predetermined amount. Movement of the first end effector 3 to the first side in the turnover direction is not limited to precise horizontal movement (i.e., movement in the XY plane), and may only be required to be movement including a movement component in the horizontal direction. That is, such movement of the first end effector 3 includes linear or curved diagonally-upward or -downward movement to the first side in the turnover direction. In this example, the first end effector 3 moves in the horizontal direction.

Upon completion of the lifting operation, the workpiece W hangs from the first end effector 3 with the second end portion w12 being a free end. Since the workpiece W has the flexibility, the second end portion w12 moves, as shown in FIG. 11, to the first side in the turnover direction a little later than movement of the first end effector 3 to the first side in the turnover direction.

By such preliminary operation, a state in which the first portion w21 is positioned on the second side in the turnover direction with respect to the second portion w22 can be brought. The first sheet surface s1 of the workpiece W hanging from the first end effector 3 faces the second side in the turnover direction. Thus, at a large portion of the workpiece W, particularly the intermediate portion of the workpiece W, the first sheet surface s1 faces diagonally downward.

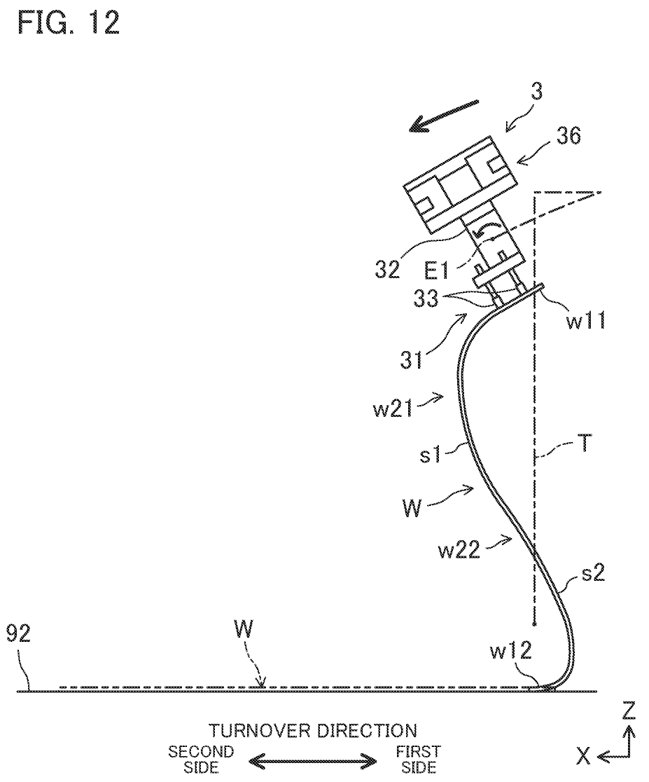

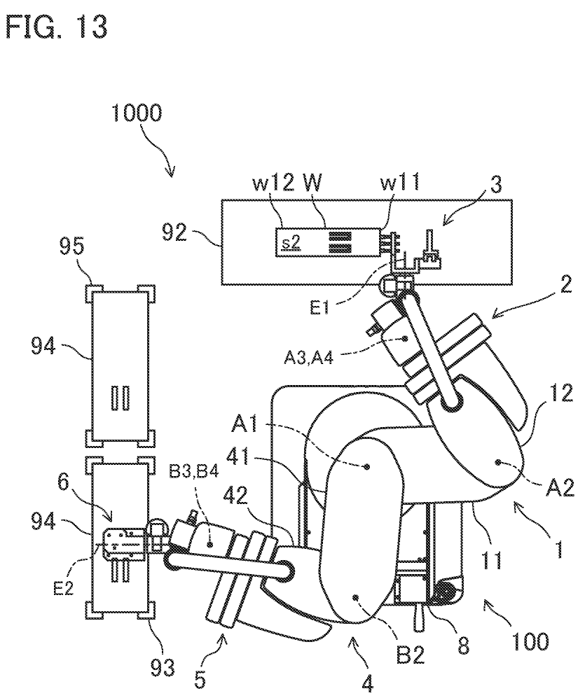

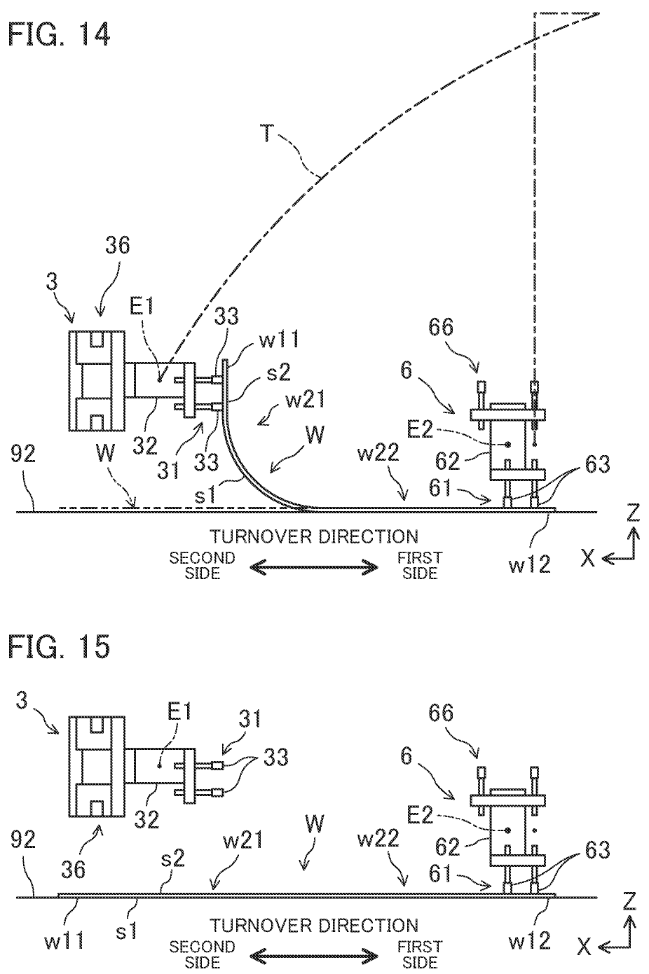

Next, the controller 7 causes the first robot arm 1 to execute lowering operation. FIG. 12 is a schematic view showing, from the front of the robot 100, the states of the workpiece W and the first end effector 3 in a first phase of the lowering operation. FIG. 13 is a plan view of the robot 100 in a final phase of the lowering operation FIG. 14 is a schematic view showing, from the front of the robot 100, the states of the workpiece W and the first end effector 3 upon completion of the lowering operation.

In the lowering operation, the first robot arm 1 lowers the first end effector 3 with the first sheet surface s1 facing downward. The phrase “the first sheet surface s1 facing downward” as described herein includes not only a case where the normal to the first sheet surface s1 faces vertically downward, i.e., immediately below, but also a case where the normal to the first sheet surface s1 faces diagonally downward.

The controller 7 causes the first robot arm 1 to lower the first end effector 3 immediately after execution of the preliminary operation. That is, before stop of displacement of the second end portion w12 of the workpiece W by the preliminary operation, the first robot arm 1 starts lowering the first end effector 3. Specifically, when the second end portion w12 is moved to the first side in the turnover direction by inertia or the second end portion w12 is positioned on the first side in the turnover direction with respect to the first end portion w11, lowering of the first end effector 3 is started

Accordingly, the first end effector 3 is easily lowered with the first sheet surface s1 facing downward.

Further, the first robot arm 1 executes a lateral movement operation of moving the first end effector 3 to the second side in the turnover direction while lowering the first end effector 3. That is, the first robot arm 1 moves, in the lowering operation, the first end effector 3 diagonally downward to the second side in the turnover direction. That is, as shown in FIGS. 12 and 14, the first end effector 3 moves diagonally downward along the curved or linear trajectory T.

While the first end effector 3 is moving (including not only movement in the horizontal direction, but also diagonal downward movement) to the second side in the turnover direction, the second end portion w12 moves a little later than movement of the first end effector 3 because of the flexibility of the workpiece W. That is, a state in which the first portion w21 is positioned on the second side in the turnover direction with respect to the second portion w22, i.e., a state in which the first sheet surface s1 faces diagonally downward at a large portion of the workpiece W, particularly the intermediate portion of the workpiece W, is brought. In this manner, a state in which the first sheet surface s1 faces downward can be brought by the lateral movement operation. The first end effector 3 is lowered in this state, and accordingly, the workpiece W can be laid on the turnover station 92 with the first sheet surface s1 facing downward.

That is, any of the preliminary operation and the horizontal movement can facilitate a transition to a state in which the first sheet surface s1 faces downward. In this example, both the preliminary operation and the lateral movement operation are executed

The lowering operation is continued until the first end effector 3 is lowered to a position (hereinafter referred to as a “completion position”) at which the first end effector 3 separates from the turnover station 92 by a predetermined distance, as shown in FIG. 14.

Further, the controller 7 causes the first end effector 3 to execute rotary operation during the lowering operation.

Specifically, in the rotary operation, the first end effector 3 rotates about the first rotation axis E1 in a direction of raising the first end portion w11 of the workpiece W. At the start of the lowering operation, the held portion of the workpiece W is substantially in the horizontal state. Since the first end effector 3 holds the first end portion w11 of the workpiece W or the vicinity thereof, the first end portion w11 is also substantially in the horizontal state. From this state, the first end effector 3 rotates about the first rotation axis E1 in a direction of raising the first end portion w11. For example, the first end effector 3 rotates about 90 degrees during the lowering operation. When the first end effector 3 reaches the completion position, the first end portion w11 stands substantially in the vertical direction.

The phrase “a direction of raising the first end portion w11 of the workpiece W about the first rotation axis E1” as described herein only specifies a rotation direction of the first end effector 3, and does not mean that the first end portion w11 is brought into the standing state. That is, the rotation direction about the first rotation axis E1 includes two directions, i.e., a direction of raising the first end portion w11 and a direction of hanging down the first end portion w11. A “direction of raising the first end portion w11 of the workpiece W about the first rotation axis E1” means a direction of raising the first end portion w11, i.e., a rotation direction of moving the first end portion w11 upward, among two rotation directions about the first rotation axis E1. As long as the first end effector 3 rotates in this direction, rotation of the first end effector 3 may be stopped before the first end portion w11 stands vertically, or may be continued until the first end portion w11 tilts to the horizontal state beyond the vertically-standing state.

By such rotary operation, the workpiece W can be, in the lowering operation, smoothly laid on the turnover station 92 with the first sheet surface s1 facing downward. That is, if the lowering operation is performed with the first end effector 3 keeping the posture thereof upon completion of the holding operation (i.e., without the first end effector 3 changing the rotation angle thereof about the first rotation axis E1), a portion of the workpiece W laid on the turnover station 92 is in such a state that the first sheet surface s1 faces downward, and on the other hand, the first sheet surface s1 of the held portion of the workpiece W faces upward. Thus, the workpiece W is excessively curved. By execution of the rotary operation, the first sheet surface s1 of the held portion of the workpiece W rotates from the upward state to a state in which the first sheet surface s1 faces the second side in the turnover direction. Such a rotation direction is a rotation direction when the first end portion w11 is laid on the turnover station 92 with the first sheet surface s1 facing downward That is, this state is a state after turnover of the first sheet surface s1 of the first end portion w11 from the upward state to the downward state has progressed. Accordingly, curving of the workpiece W in the lowering operation is reduced.

While the first robot arm 1 and the first end effector 3 are performing the holding operation, the lifting operation, the preliminary operation, and the lowering operation, the controller 7 causes the second robot arm 4 and the second end effector 6 to dispose the jig plate 94 on the installation station 93. Specifically, the second robot arm 4 takes out one jig plate 94 from the plate storage 95, and disposes the taken-out jig plate 94 on the plate storage 95.

Specifically, the second end effector 6 faces the second sucker 66 downward. As shown in FIG. 8, the second robot arm 4 moves the second sucker 66 to a predetermined suction portion of the jig plate 94 in the plate storage 95. The second sucker 66 sucks the jig plate 94. As shown in FIG. 13, the second robot arm 4 delivers the jig plate 94 to the installation station 93. The second sucker 66 releases the sucked jig plate 94 Accordingly, the jig plate 94 is disposed on the installation station 93.

In this manner, while the first robot arm 1 and the first end effector 3 are executing the holding operation, the lifting operation, the preliminary operation, and the lowering operation, the second robot arm 4 and the second end effector 6 dispose, as preparation for the installation process, the jig plate 94 on the installation station 93.

After or during (at least after the second end portion w12 has been laid on the turnover station 92 with the first sheet surface s1 facing downward) the above-described lowering operation in the turnover process, the controller 7 causes the second end effector 6 to execute pressing operation. In the pressing operation, the second end effector 6 presses a portion of the workpiece W at which the first sheet surface s1 contacts the turnover station 92. Specifically, after completion of disposing of the jig plate 94 on the installation station 93, the second end effector 6 faces the first sucker 61 downward. The second robot arm 4 moves the second vision sensor 69 to above the second end portion w12 of the workpiece W The second vision sensor 69 images the second end portion w12 of the workpiece W, and the controller 7 acquires the position and shape of the second end portion w12. The controller 7 controls the second robot arm 4 based on the acquired position and shape of the second end portion w12.

The second robot arm 4 moves the second end effector 6, specifically the first sucker 61, to the second end portion w12. Then, the second robot arm 4 presses the second end portion w12, i.e., the second portion w22, against the turnover station 92 from above by the first suction pads 63 of the first sucker 61, as shown in FIG. 14 Accordingly, the position of the workpiece W on the turnover station 92 is determined.

Subsequently, the controller 7 causes the first end effector 3 to execute release operation. FIG. 15 is a schematic view showing, from the front of the robot 100, the states of the workpiece W, the first end effector 3, and the second end effector 6 upon completion of the release operation

In the release operation, the first end effector 3 releases the held workpiece W from the state after completion of the lowering operation. Specifically, the first end effector 3 releases the sucked workpiece W.

When the workpiece W sucked by the first end effector 3 is released, the workpiece W drops, due to the weight of the workpiece W itself, onto the turnover station 92 with the first sheet surface s1 facing downward. At this point, since the second end portion w12 is pressed by the second end effector 6, displacement of the workpiece W on the turnover station 92 while dropping is prevented

Note that after the first end effector 3 has released the held workpiece W, the first robot arm 1 may rotate the first end effector 3 about the first rotation axis E1 or move the first end effector 3 such that the first end effector 3 does not interfere with dropping of the first portion w21.

In this manner, the turnover process by the robot 100 is completed. The workpiece W is in the second state in which the first sheet surface s1 faces downward and the second sheet surface s2 faces upward. The workpiece W is turned over in the longitudinal direction, and arrangement of the first end portion w11 and the second end portion w12 in the longitudinal direction is reversed.

In this manner, the first end effector 3 executes the rotary operation before completion of the lowering operation and after the holding operation (in this example, during the lowering operation), and therefore, the workpiece W can be smoothly laid on the turnover station 92 with the first sheet surface s1 facing downward.

That is, when the first end effector 3 executes the rotary operation, the first sheet surface s1 of the held portion of the workpiece W rotates from the upward state to a state in which the first sheet surface s1 faces the second side in the turnover direction. Such movement is movement upon turnover in a state in which the first sheet surface s1 of the held portion faces downward, i.e, turnover of the held portion is facilitated. At the same time, curving of the workpiece W is also reduced.

Further, the first end effector 3 executes the rotary operation so that the workpiece W can be properly, i.e., with the first sheet surface s1 facing downward, dropped onto the turnover station 92 in the release operation.

Specifically, when the held portion is dropped from the lowering operation completion position with the first sheet surface s1 of the held portion of the workpiece W facing upward, there is a probability that the first end portion w11 is not properly dropped onto the turnover station 92 with the first sheet surface s1 facing downward. For example, there is a probability that the first end portion w11 is dropped onto an already-turned-over portion of the workpiece W and these portions of the workpiece W overlap with each other.

By execution of the rotary operation, the held portion is, upon completion of the lowering operation, in a state in which the held portion stands as compared to the horizontal state in which the first sheet surface s1 faces upward. That is, this state is a state after turnover of the held portion from the upward state to the downward state of the first sheet surface s1 has progressed. Thus, when the first end portion w11 is dropped from the completion position, the held portion is easily laid on the turnover station 92 with the first sheet surface s1 facing downward.

In addition, the first robot arm 1 executes the preliminary operation before the lifting operation, and therefore, in the lowering operation, the workpiece W is easily laid on the turnover station 92 with the first sheet surface s1 facing downward. Specifically, a state in which the first sheet surface s1 faces diagonally downward is easily brought by the preliminary operation. The first end effector 3 is lowered in this state so that the workpiece W can be smoothly laid on the turnover station 92 with the first sheet surface s1 facing downward.

According to such a turnover process, the workpiece W can be turned over by simple operation of the first robot arm 1 and the first end effector 3. For example, a method for turning over the workpiece W includes a method in which a workpiece is turned over after having been held with one end effector and is passed to another end effector. However, in the turnover process by the robot 100, the first end effector 3 can hold the workpiece W and turn over the workpiece W without the need for passing the workpiece W to another end effector.

In the turnover process by the robot 100, the first end effector 3 can turn over the workpiece W without the need for rotating the workpiece W 180 degrees after having held the workpiece W. For example, in the case of turning over a workpiece having a high stiffness, an end effector holding the workpiece needs to be rotated 180 degrees However, in the turnover process by the robot 100, the first end effector 3 holds the workpiece W with the sucker 31 facing downward, and thereafter, rotates the workpiece W about 90 degrees during the turnover process. The workpiece W is curved using the flexibility of the workpiece W in the lifting operation and the lowering operation so that the workpiece W can be turned over by small rotation of the first end effector 3.

Alternatively, in another turnover method, in a case where an end effector holds a sheet surface and turns over the workpiece W and subsequently mounts the workpiece W on the turnover station 92 with the held sheet surface facing downward, the end effector interferes with mounting of the workpiece W on the turnover station 92. For this reason, some kinds of measures need to be taken, such as passing of the workpiece W to another end effector. However, in the turnover process by the robot 100, the first robot arm 1 and the first end effector 3 curve the workpiece W by means of the flexibility of the workpiece W, and from a state in which part of the first sheet surface s1 separates from the turnover station 92 and the remaining portion of the first sheet surface s1 contacts the turnover station 92, release the held first sheet surface s1 to drop the workpiece W. In this manner, the workpiece W is eventually laid on the turnover station 92 According to this configuration, the first end effector 3 can easily lay the workpiece W on the turnover station 92 with the held first sheet surface s1 facing downward, without the need for taking the measures such as passing of the workpiece W to another end effector or formation of the turnover station 92 in such a shape that interference with the first end effector 3 can be avoided.

### Installation Process

After completion of the turnover process, the robot 100 executes an installation process of placing the workpiece W on the jig plate 94.

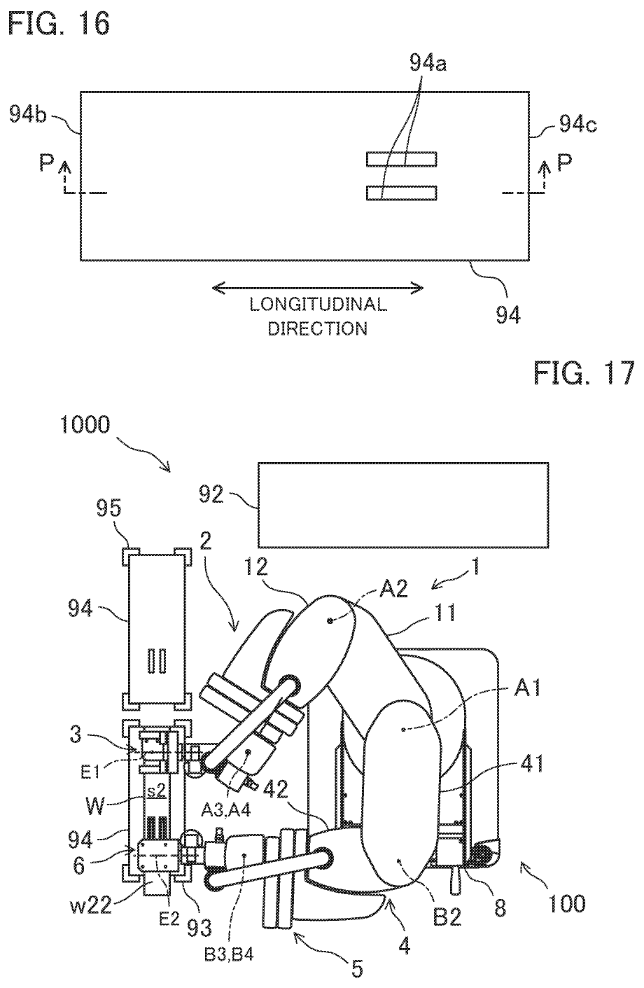

FIG. 16 is a plan view of the jig plate 94. The jig plate 94 is a plate-shaped member The jig plate 94 has a substantially-quadrangular planar shape having a pair of long sides and a pair of short sides. The jig plate 94 includes two openings 94a. The openings 94a penetrate the jig plate 94 in a thickness direction thereof. Two openings 94a are aligned in the width direction of the jig plate 94 The first protruding pieces w1 of the workpiece W are to be inserted into the openings 94a. The jig plate 94 has a first edge 94b and a second edge 94c corresponding to the pair of short sides. The first edge 94b is an engager to be engaged with the second protruding pieces w2 of the workpiece W.

First, the controller 7 causes the first robot arm 1 and the second robot arm 4 to execute delivery operation. FIG. 17 is a plan view of the robot 100 in the delivery operation.

In the delivery operation, the first robot arm 1 and the second robot arm 4 deliver the workpiece W to the jig plate 94 with the turned-over workpiece W in the second state held by the first end effector 3 and the second end effector 6 Specifically, the second end effector 6 presses the second end portion w12 of the workpiece W after completion of the turnover process, and therefore, in this state, sucks the workpiece W by the first sucker 61.

Meanwhile, the first robot arm 1 moves the first vision sensor 311 to above the first end portion w11 of the workpiece W The first vision sensor 311 images the first end portion w11 of the workpiece W, and the controller 7 acquires the position and shape of the first end portion w11. Based on the acquired position and shape of the first end portion w11, the first robot arm 1 moves the first end effector 3, specifically the sucker 31, to the first end portion w11. Then, the sucker 31 sucks the workpiece W.

Thereafter, the first robot arm 1 and the second robot arm 4 deliver the workpiece W to the jig plate 94 on the installation station 93 with the workpiece W held by the sucker 31 and the first sucker 61.

The workpiece W is mounted on the jig plate 94 with the longitudinal direction of the workpiece W being coincident with the longitudinal direction of the jig plate 94. The workpiece W is disposed on the jig plate 94 such that an edge of the first end portion w11 is aligned with the first edge 94b of the jig plate 94 and the second portion w22 crosses the second edge 94c of the jig plate 94. When the first robot arm 1 and the second robot arm 4 mount the workpiece W on the jig plate 94, the first robot arm 1 and the second robot arm 4 cause the second protruding pieces w2 of the workpiece W to engage with the first edge 94b of the jig plate 94. The second protruding pieces w2 are bent from the workpiece body w0. The first robot arm 1 and the second robot arm 4 move, starting from the second end portion w12, the workpiece W to the first edge 94b of the jig plate 94 in the longitudinal direction thereof, and accordingly, the second protruding pieces w2 engage with the first edge 94b. Note that a method for engaging the second protruding pieces w2 with the first edge 94b is not limited to above. By engagement among the second protruding pieces w2 and the first edge 94b, movement of the workpiece W in the longitudinal direction of the jig plate 94 is limited.

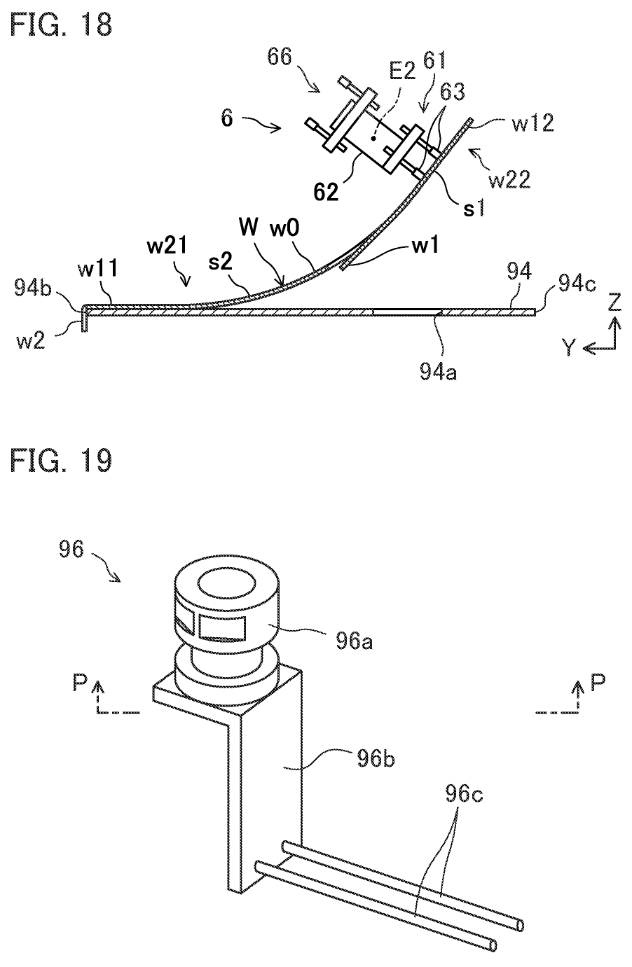

Next, the controller 7 causes the second robot arm 4 to execute separating operation. FIG. 18 is a schematic view showing, in the width direction of the workpiece W, the states of the workpiece W and the second end effector 6 in the separating operation. In FIG. 18, the workpiece W and the jig plate 94 are shown by a sectional view along a P-P line of FIG. 16.

In the separating operation, the second robot arm 4 lifts the second end effector 6 holding the workpiece W such that the first protruding pieces w1 separate from the jig plate 94. By such separating operation, a space is formed among the first protruding pieces w1 and the jig plate 94. Further, the second end portion w12 of the workpiece W is positioned higher than the first end portion w11, and therefore, the first protruding pieces w1 are inclined such that the free ends thereof are positioned on the lowermost side.

In addition, the controller 7 causes the second end effector 6 to execute curving operation during the separating operation. In the curving operation, the second end effector 6 rotates about the second rotation axis E2 such that the workpiece W is curved with the second sheet surface s2 inside and the first sheet surface s1 outside By such curving of the workpiece W, such inclination of the first protruding pieces w1 that the free ends are positioned on the lowermost side is facilitated. Since the first protruding pieces w1 are in the cantilever shape, the free ends of the first protruding pieces w1 slightly protrude downward from the curved workpiece body w0.

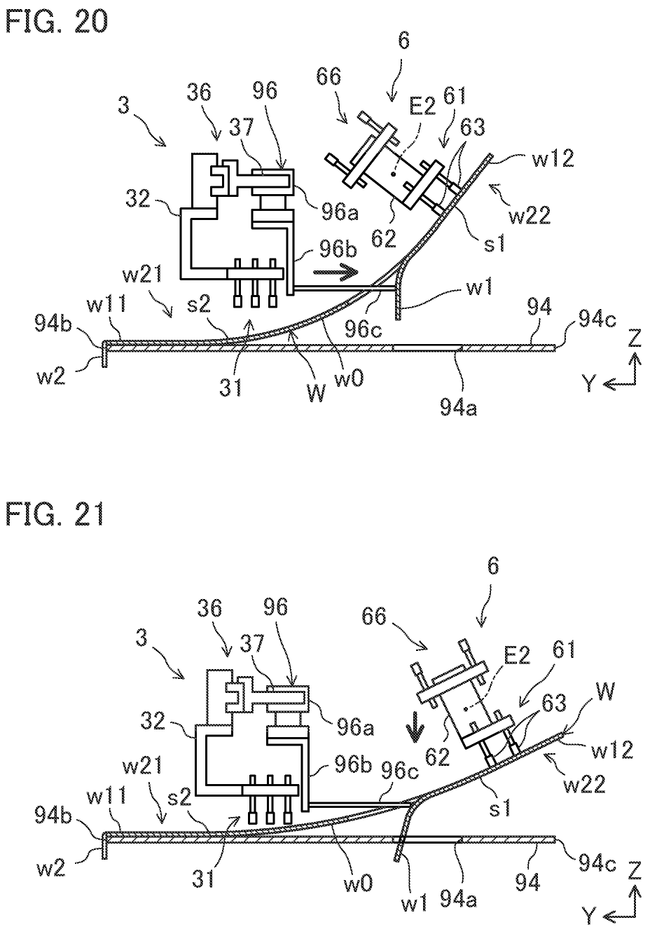

Subsequently, the controller 7 causes the first robot arm 1 and the first end effector 3 to execute pushout operation. In the pushout operation, the first robot arm 1 causes the first end effector 3 to push the first protruding pieces w1 such that the free ends of the first protruding pieces w1 protrude downward from the workpiece body w0. The first end effector 3 pushes the first protruding pieces w1 through a pushout tool 96. FIG. 19 is a perspective view of the pushout tool 96. FIG. 20 is a schematic view showing, in the width direction of the workpiece W, the states of the workpiece W, the first end effector 3, and the second end effector 6 in the pushout operation. In FIG. 20, the workpiece W and the jig plate 94 are also shown by a sectional view along the P-P line of FIG. 16.

The pushout tool 96 has a cylindrical grip 96a, a bracket 96b coupled to the grip 96a, and two pins 96c located at the bracket 96b The bracket 96b is in the form of a plate having an L-shaped section. Two pins 96c extend parallel with each other. Moreover, two pins 96c extend substantially parallel with a radial direction of the grip 96a. An interval (a distance between the centers) between two pins 96c corresponds to that between two first protruding pieces w1. The pushout tool 96 is one example of a tool for pushing the first protruding pieces w1.

The controller 7 causes, as preparation for the pushout operation, the first end effector 3 to grip the pushout tool 96 during the separating operation and the curving operation. Specifically, the hand 36 grips the grip 96a of the pushout tool 96 with the pair of fingers 37.

The first robot arm 1 moves the first end effector 3 to push in the first protruding pieces w1 by two pins 96c of the pushout tool 96 from a second sheet surface s2 side to a first sheet surface s1 side. Accordingly, a large portion of the first protruding pieces w1 including the free ends thereof protrudes downward from the workpiece body w0. The free ends of the first protruding pieces w1 are positioned above the openings 94a of the jig plate 94.

Thereafter, the controller 7 causes the second robot arm 4 and the second end effector 6 to execute insertion operation. FIG. 21 is a schematic view showing, in the width direction of the workpiece W, the states of the workpiece W, the first end effector 3, and the second end effector 6 in the insertion operation. In FIG. 21, the workpiece W and the jig plate 94 are also shown by a sectional view along the P-P line of FIG. 16.

In the insertion operation, the second robot arm 4 lowers the second end effector 6 such that the free ends of the first protruding pieces w1 are inserted into the openings 94a of the jig plate 94. By the previous pushout operation, the free ends of the first protruding pieces w1 are disposed above the openings 94a of the jig plate 94. Thus, when the first protruding pieces w1 are lowered, the free ends of the first protruding pieces w1 are inserted into the openings 94a.

The second robot arm 4 lowers the second end effector 6 until the second end portion w12 of the workpiece W is mounted on the jig plate 94. At this point, the second end effector 6 rotates about the second rotation axis E2 such that the curved workpiece W returns to a flat state. Since the first protruding pieces w1 also lower in association with lowering of the second end effector 6, the first end effector 3 also lowers while keeping pushing the first protruding pieces w1.

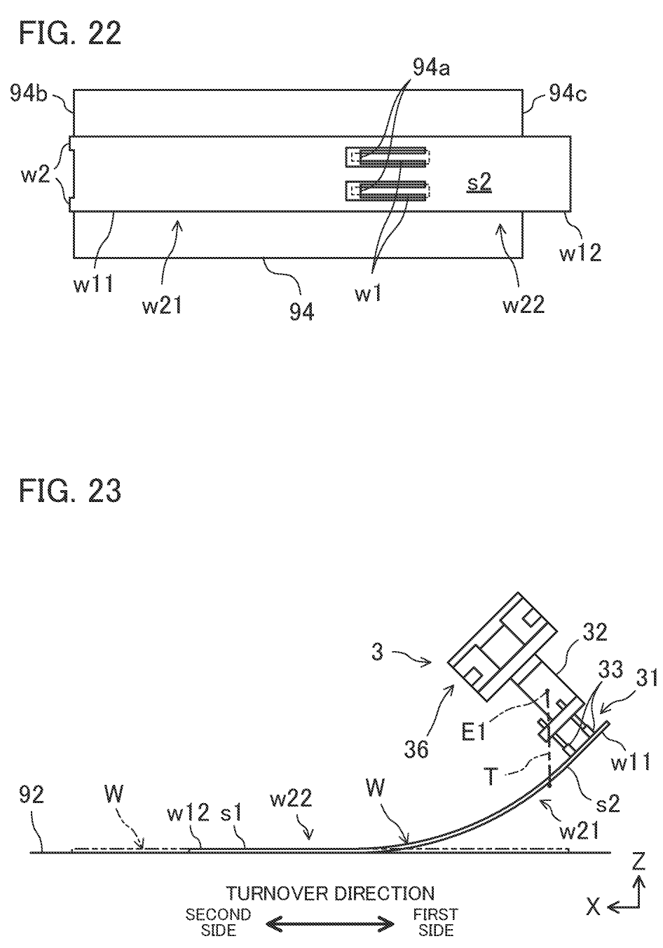

FIG. 22 is a plan view of the workpiece W placed on the jig plate 94 Upon completion of the insertion operation, the first protruding pieces w1 are inserted into the openings 94a, and the workpiece W is mounted in the flat state on the jig plate 94. In this manner, the installation process is completed.

The workpiece W placed on the jig plate 94 is delivered to the next step together with the jig plate 94.

According to such an installation process, the first protruding pieces w1 are pushed in by means of the flexibility of the workpiece W so that the first protruding pieces w1 can protrude downward from the workpiece W. The first protruding pieces w1 protrude downward so that the first protruding pieces w1 can be easily inserted into the openings 94a of the jig plate 94 by lowering of the workpiece W.

When the first protruding pieces w1 are pushed, the second end effector 6 rotates to curve the workpiece W so that the inclination angle of the first protruding piece w1 can be increased. Accordingly, the free ends of the first protruding pieces w1 can face downward by a slight push-in amount.

As described above, the robot 100 turns over the sheet-shaped workpiece W, which is mounted on the turnover station 92 (a base) in the first state in which the first sheet surface s1 faces upward and the second sheet surface s2 faces downward and has the flexibility, such that arrangement of the first end portion w11 positioned on the first side in the predetermined turnover direction and the second end portion w12 positioned on the second side in the turnover direction is reversed, thereby bringing the workpiece W into the second state in which the first sheet surface s1 faces downward and the second sheet surface s2 faces upward. The robot 100 includes the first robot arm 1, the first end effector 3 that is coupled to the first robot arm 1 so as to rotate about the predetermined first rotation axis E1, and the controller 7 that controls the first robot arm 1 and the first end effector 3. The controller 7 turns over the workpiece W into the second state by causing the first end effector 3 to execute a holding operation of holding the first portion w21, which is the portion including the first end portion w11 when the workpiece W is divided in half in the turnover direction, of the workpiece W in the first state with the first rotation axis E1 being parallel with the first sheet surface s1 and the second sheet surface s2, causing the first robot arm 1 to execute, after the holding operation, a lifting operation of lifting the first end effector 3 such that the second sheet surface s2 separates from the turnover station 92, causing the first robot arm 1 to execute, after the lifting operation, a lowering operation of lowering the first end effector 3 with the first sheet surface s1 facing downward, and causing the first end effector 3 to execute, before completion of the lowering operation and after the holding operation, a rotary operation of rotating about the first rotation axis E1 in a direction of raising the first end portion w11.

According to this configuration, the first robot arm 1 lifts the first end effector 3 with the first end effector 3 holding the first portion w21 of the workpiece W, and in this manner, the workpiece W hangs from the first end effector 3 with the first sheet surface s1 facing the second side in the turnover direction. From this state, the first robot arm 1 lowers the first end effector 3 with the first sheet surface s1 facing downward. Upon completion of the holding operation, the first sheet surface s1 of the held portion, which is held by the first end effector 3, of the workpiece W faces upward. As the first end effector 3 rotates in a direction of raising the first end portion w11 by the rotary operation, the first sheet surface s1 of the held portion change the direction thereof so as to face the second side in the turnover direction. Such movement is the same as movement upon turnover in a state in which the first sheet surface s1 of the held portion faces downward. Since the rotary operation is performed before completion of the lowering operation, the workpiece W can be smoothly laid on the turnover station 92 with the first sheet surface s1 facing downward while curving of the workpiece W is reduced. As a result, the workpiece W can be turned over by simple operation without the need for picking up the workpiece W again after the workpiece W has been temporarily put on a certain location or passing the workpiece W to another end effector.

The controller 7 causes the first robot arm 1 to execute, during the lowering operation, a lateral movement operation of moving the first end effector 3 to the second side in the turnover direction.

According to this configuration, a state in which the first sheet surface s1 faces downward is easily brought. Specifically, the workpiece W is, by the lifting operation, brought into a state in which the workpiece W hangs from the first end effector 3 From this state, when the first end effector 3 moves to the second side in the turnover direction, the second end portion w12 moves a little later than movement of the first end effector 3 due to the flexibility of the workpiece W, and accordingly, a state in which the first portion w21 is positioned on the second side in the turnover direction with respect to the second portion w22 is brought. As a result, the first sheet surface s1 faces downward at a large portion of the workpiece W, particularly the intermediate portion of the workpiece W.

The controller 7 causes the first robot arm 1 to execute, after the lifting operation and before the lowering operation, a preliminary operation of moving the first end effector 3 to the first side in the turnover direction

According to this configuration, the force of inertia to the first side in the turnover direction is provided to the second end portion w12 of the workpiece W by the preliminary operation, and therefore, at the start of the lowering operation, the second end portion w12 can be positioned on the first side in the turnover direction with respect to the first end portion w11 As a result, a state in which the first sheet surface s1 faces diagonally downward is easily brought at the start of the lowering operation

The rotary operation is executed at least during the lowering operation.

According to this configuration, curving of the workpiece W caused in the rotary operation can be reduced. In the lowering operation, the workpiece W is, starting from the second end portion w12, laid on the turnover station 92 with the first portion w21 held by the first end effector 3, and therefore, the workpiece W is curved. At this point, the rotary operation is executed so that the workpiece W can be smoothly laid on the turnover station 92 with the first sheet surface s1 facing downward while curving of the workpiece W is reduced.

In the lowering operation, the first robot arm 1 lowers the first end effector 3 to the completion position (a predetermined position) apart from the installation station 93. The controller 7 causes the first end effector 3 to execute, after the lowering operation, a release operation of releasing the held workpiece W.

According to this configuration, the first end effector 3 drops, after the lowering operation, the held portion of the workpiece W onto the turnover station 92 from the completion position. Accordingly, the turned-over workpiece W is eventually laid on the turnover station 92. Since the workpiece W has the flexibility, the workpiece W can be laid on the turnover station 92 in such a manner that the workpiece W is lowered to a certain position and is dropped from such a position. The first end effector 3 does not need to deliver the workpiece W until the entirety of the workpiece W is laid on the turnover station 92, and therefore, eg., interference between the first end effector 3 and the turnover station 92 does not need to be taken into consideration. As a result, the workpiece W can be turned over by simple operation.

The workpiece W is in the shape extending in the predetermined longitudinal direction, the first end portion w11 is one end portion of the workpiece W in the longitudinal direction, and the second end portion w12 is the other end portion of the workpiece W in the longitudinal direction.

According to this configuration, the workpiece W can be turned over in the longitudinal direction.

The robot 100 further includes the second robot arm 4 and the second end effector 6 that is coupled to the second robot arm 4. The controller 7 causes the second end effector 6 to execute, before the release operation, a pressing operation of pressing the portion of the workpiece W at which the first sheet surface s1 contacts the turnover station 92.

According to the above-described release operation, there is a probability that the workpiece W slides on the turnover station 92 while the workpiece W is dropping. For this reason, before the first end effector 3 releases the held workpiece W, the second end effector 6 presses the portion of the workpiece W at which the first sheet surface s1 contacts the turnover station 92. This prevents sliding of the workpiece W. As a result, the position of the workpiece W upon dropping of the workpiece W can be determined.

The robot 100 further includes the second robot arm 4 and the second end effector 6 that is coupled to the second robot arm 4 so as to rotate about the predetermined second rotation axis E2. The workpiece W has the workpiece body w0 and the first protruding pieces w1 coupled to the workpiece body w0 in a cantilever manner. The controller 7 causes the first robot arm 1 and the second robot arm 4 to execute a delivery operation of delivering the workpiece W to the jig plate 94 (a jig) with the first end effector 3 and the second end effector 6 holding the turned-over workpiece W in the second state, causes the second robot arm 4 (one of the first robot arm or the second robot arm) to execute a separating operation of lifting the second end effector 6 (a corresponding one of the first end effector or the second end effector) holding the workpiece W such that the first protruding pieces w1 separate from the jig plate 94, causes the first robot arm 1 (the other one of the first robot arm or the second robot arm) to execute a pushout operation of pushing the first protruding pieces w1 by the first end effector 3 (a corresponding one of the first end effector or the second end effector) such that the free ends of the first protruding pieces w1 protrude downward from the workpiece body w0, and causes the second robot arm 4 to execute an insertion operation of lowering the second end effector 6 such that the free ends of the first protruding pieces w1 is inserted into the openings 94a located at the jig plate 94

According to this configuration, the first protruding pieces w1 protrude downward from the workpiece body w0 by means of the flexibility of the workpiece W, and therefore, the first protruding pieces w1 can be inserted into the openings 94a when the workpiece W is placed on the jig plate 94. At this point, the space is formed among the jig plate 94 and the first protruding pieces w1 by the separating operation, and therefore, the space to which the first protruding pieces w1 protrude downward can be ensured. The first protruding pieces w1 of the workpiece W can be inserted into the openings 94a of the jig plate 94 by such simple operation.

The second robot arm 4 lifts, in the separating operation, the second end effector 6 such that the end portions of the first protruding pieces w1 coupled to the workpiece body w0 are positioned higher than the free ends of the first protruding pieces.

According to this configuration, when the second end effector 6 partially lifts the workpiece W in the separating operation, the workpiece W is lifted such that the portions of the first protruding pieces w1 coupled to the workpiece body w0 are positioned higher than the free ends of the first protruding pieces w1. Accordingly, the first protruding pieces w1 are, only by lifting of the workpiece W, brought into a state in which the free ends are hanging due to the weights of the first protruding pieces w1 themselves. As a result, the amount of pushing the first protruding pieces w1 such that the free ends of the first protruding pieces w1 protrude downward from the workpiece body w0 in the pushout operation, i.e., the amount of movement of the first end effector 3, can be reduced.

In addition, the controller 7 causes the second end effector 6 holding the workpiece W in the separating operation to execute, before the pushout operation, a curving operation of curving the workpiece W with the second sheet surface s2 inside and the first sheet surface s1 outside by rotating about the second rotation axis E2 (a corresponding one of the first rotation axis or the second rotation axis).

According to this configuration, a state in which the free ends of the first protruding pieces w1 protrude downward from the workpiece body w0 is naturally brought by the curving operation. Specifically, the first protruding pieces w1 are in the cantilever shape. Thus, the first protruding pieces w1 are not curved as in the workpiece W even when the workpiece W is curved, and extend in a direction tangential to portions of the workpiece W to which the first protruding pieces w1 are coupled. The workpiece W is curved with the facing-upward second sheet surface s2 inside and the downward-facing first sheet surface s1 outside. As a result, the free ends of the first protruding pieces w1 are positioned outside the first sheet surface s1, i.e., lower than the first sheet surface s1. Such curving operation is combined with an operation of lifting the workpiece such that the portions of the first protruding pieces w1 coupled to the workpiece body w0 are positioned higher than the free ends of the above-described first protruding pieces w1, and in this manner, the amount of downward protrusion of the free end of the first protruding piece w1 from the workpiece body w0 can be naturally increased. As a result, the amount of such pushing of the first protruding piece w1 that the free ends of the first protruding pieces w1 protrude downward from the workpiece body w0 in the pushout operation, i.e, the amount of movement of the first end effector 3, can be further reduced.

In the pushout operation, the first end effector 3 pushing the first protruding pieces w1 grips the pushout tool 96 (a tool) for pushing the first protruding pieces w1 to push the first protruding pieces w1 by the pushout tool 96.

According to this configuration, the first end effector 3 can grip the pushout tool 96 in the pushout operation, and can release the gripped pushout tool 96 in operation other than the pushout operation. Thus, the first end effector 3 can execute the pushout operation by means of the tool suitable for the pushout operation, i.e., the pushout tool 96. On the other hand, in operation other than the pushout operation, the first end effector 3 can release the gripped pushout tool 96, and therefore, interference of the pushout tool 96 with operation other than the pushout operation can be avoided.

The workpiece W further has the second protruding pieces w2 bent from the workpiece body w0, and in the delivery operation, the first robot arm 1 and the second robot arm 4 cause the second protruding pieces w2 to engage with the first edge 94b (an engager) located at the jig plate 94.

According to this configuration, displacement of the position of the workpiece W in the separating operation can be prevented. As a result, the free ends of the first protruding pieces w1 can be properly inserted into the openings 94a in the insertion operation.

### Variation

Subsequently, a turnover process according to a variation of the robot 100 will be described. In the turnover process according to the variation, operation of the first robot arm 1 and the first end effector 3 is different from that described above

First, the controller 7 causes the first end effector 3 to execute a holding operation of holding the workpiece W. The holding operation is similar to the above-described holding operation.

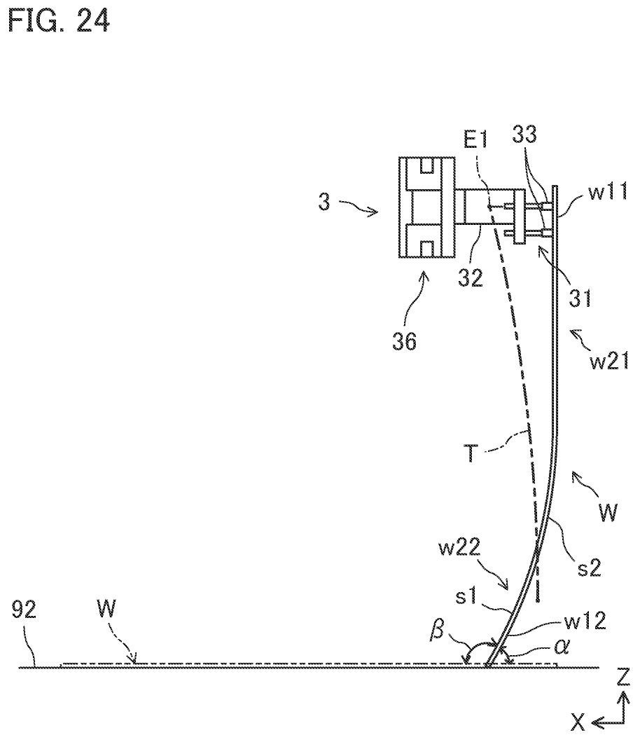

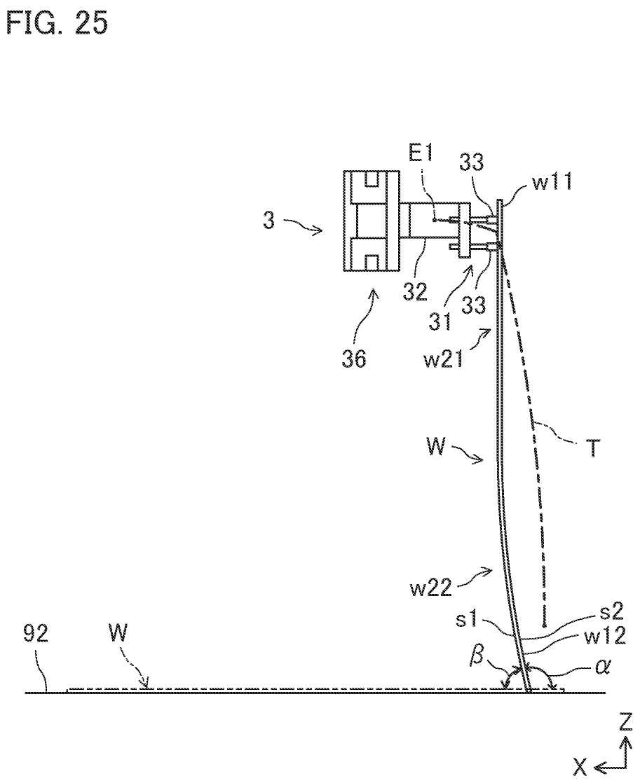

Subsequently, the controller 7 causes the first robot arm 1 and the first end effector 3 to execute the lifting operation. FIG. 23 is a schematic view showing, from the front of the robot 100, the states of the workpiece W and the first end effector 3 in the first phase of the lifting operation in the turnover process according to the variation FIG. 24 is a schematic view showing, from the front of the robot 100, the states of the workpiece W and the first end effector 3 in the final phase of the lifting operation. FIG. 25 is schematic view showing, from the front of the robot 100, the states of the workpiece W and the first end effector 3 upon completion of the lifting operation.

In the lifting operation, the first robot arm 1 lifts the first end effector 3 such that the second sheet surface s2 separates from the turnover station 92. In addition, during the lifting operation, the first end effector 3 executes a rotary operation of rotating about the first rotation axis E1 in a direction of raising the first end portion w11.

Specifically, the first robot arm 1 lifts the first end effector 3. For example, the first end effector 3 is lifted diagonally upward to the second side in the turnover direction with respect to the vertical direction. At this point, the first end effector 3 is lifted along the curved trajectory T. Note that the first end effector 3 may be lifted in the vertical direction (i.e., an immediate-upward direction).

In parallel, the first end effector 3 executes the rotary operation Accordingly, the workpiece W is curved with the first sheet surface s1 inside and the second sheet surface s2 outside.

By lifting and rotation of the first end effector 3, the workpiece W is lifted up starting from a first end portion w11 side. That is, the second sheet surface s2 gradually separates from the turnover station 92 from the first end portion w11 to the second end portion w12.

Lifting of the first end effector 3 is continued until the substantially entirety of the second sheet surface s2 separates from the turnover station 92. Moreover, rotation of the first end effector 3 is continued until the first sheet surface s1 and the second sheet surface s2 of the held portion of the workpiece W become substantially parallel with the vertical direction (i.e, until the sucker 31 faces substantially the horizontal direction).

By such lifting and rotation of the first end effector 3, an angle (hereinafter referred to as a “first angle”) α between the second sheet surface s2 of the lower end portion (in this example, the second end portion w12) of the workpiece W and the turnover station 92 can be increased to around 90 degrees in the final phase of the lifting operation. With the increased first angle α, the second end portion w12 is easily tilted to the second side in the turnover direction. That is, a smooth transition to the subsequent lowering operation can be made.

Note that lifting and rotation of the first end effector 3 are not limited to above. For example, lifting of the first end effector 3 may be continued even after the substantially entirety of the second sheet surface s2 has separated from the turnover station 92, or be stopped in a state in which the second sheet surface s2 of the second end portion w12 does not fully separate from the turnover station 92 Rotation of the first end effector 3 may be continued until the sucker 31 faces diagonally upward beyond the horizontal direction

The controller 7 causes the first robot arm 1 to execute the lateral movement operation during the lifting operation. In the lateral movement operation, the first robot arm 1 moves the first end effector 3 to the second side in the turnover direction. In this example, the lateral movement operation is executed from the first phase of the lifting operation.

The first end effector 3 moves diagonally upward to the second side in the turnover direction by a combination of the lifting operation and the lateral movement operation By the lateral movement operation, an angle (hereinafter referred to as a “second angle”) β between the first sheet surface s1 of the second end portion w12 and the turnover station 92 is switched from 90 degrees or more (a state shown in FIG. 24) to less than 90 degrees (a state shown in FIG. 25). Accordingly, the workpiece W is curved with the first sheet surface s1 outside and the second sheet surface s2 inside.

Since the first angle α is increased in the final phase of the lifting operation by rotation of the first end effector 3, the workpiece W can be easily brought into a state of the second angle β being less than 90 degrees by the lateral movement operation.

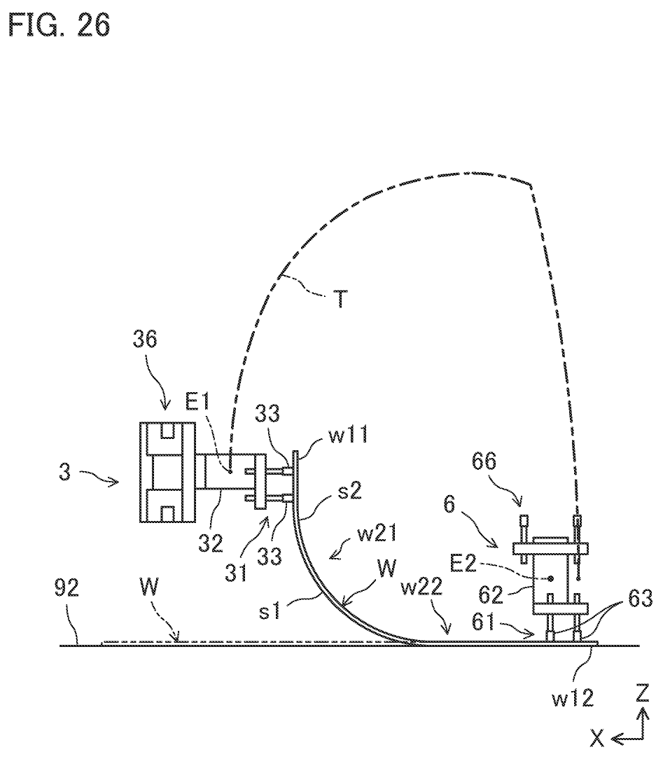

Subsequently, the controller 7 causes the first robot arm 1 to execute the lowering operation. FIG. 26 is a schematic view showing, from the front of the robot 100, the states of the workpiece W, the first end effector 3, and the second end effector 6 upon completion of the lowering operation.

In the lowering operation, the first robot arm 1 lowers the first end effector 3 with the first sheet surface s1 facing downward.

By the above-described lateral movement operation during the lifting operation, the workpiece W is in a state of the second angle β of the second end portion w12 being less than 90 degrees, i.e., a state of the first sheet surface s1 of the second end portion w12 facing diagonally downward The controller 7 causes the first robot arm 1 to transition from the lifting operation to the lowering operation after the second angle β of the workpiece W has reached less than 90 degrees Accordingly, the first end effector 3 lowers with the first sheet surface s1 facing downward. Note that the controller 7 also continues the lateral movement operation during the lowering operation As a result, the first end effector 3 moves diagonally downward along the curved or linear trajectory T.

The workpiece W is, at the first sheet surface s1 thereof, laid on the turnover station 92 in an order from the second portion w22 to the first portion w21 in such a curved state that the first sheet surface s1 faces outside and the second sheet surface s2 faces inside.

The lateral movement operation is also continued during the lowering operation so that the workpiece W can be laid on the turnover station 92 without the need for moving the position of the second portion w22 on the turnover station 92 much

After the first end effector 3 has been lowered from the turnover station 92 to the completion position, the controller 7 ends the lowering operation.

While the first robot arm 1 and the first end effector 3 are performing the holding operation, the lifting operation, and the lowering operation, the controller 7 causes the second robot arm 4 and the second end effector 6 to dispose the jig plate 94 on the installation station 93 as described above.

After the above-described lowering operation in the turnover process, the controller 7 causes the second end effector 6 to execute the pressing operation. The pressing operation is similar to the above-described pressing operation.

Subsequently, the controller 7 causes the first end effector 3 to execute the release operation. The release operation is similar to the above-described release operation.

In this manner, the turnover process by the robot 100 is completed. The workpiece W is in the second state in which the first sheet surface s1 faces downward and the second sheet surface s2 faces upward. The workpiece W is turned over in the longitudinal direction, and arrangement of the first end portion w11 and the second end portion w12 in the longitudinal direction is reversed.

In this manner, the workpiece W is curved with the first sheet surface s1 inside and the second sheet surface s2 outside when the workpiece W is lifted, and therefore, can be lifted such that the second sheet surface s2 of the workpiece W stands at an angle perpendicular or substantially perpendicular to the turnover station 92. Accordingly, the workpiece W is easily tilted to the first sheet surface s1 side such that the second angle β is less than 90 degrees in the subsequent lowering operation or the lateral movement operation. That is, the first end effector 3 is rotated considering the flexibility of the workpiece W upon lifting of the workpiece W so that the workpiece W can be smoothly turned over.

According to such a turnover process, the first end effector 3 can hold the workpiece W, and turn over the workpiece W without the need for passing the workpiece W to another end effector. Moreover, in the turnover process by the robot 100, the workpiece W can be turned over without the need for rotating the workpiece W 180 degrees after the first end effector 3 has held the workpiece W. Further, in the turnover process by the robot 100, the first end effector 3 can easily lay the workpiece W on the turnover station 92 with the held first sheet surface s1 facing downward, without the need for taking the measures such as formation of the turnover station 92 in such a shape that interference with the first end effector 3 can be avoided. As a result, the workpiece W can be turned over by simple operation of the first robot arm 1 and the first end effector 3.

As described above, also in the variation, the robot 100 turns over the sheet-shaped workpiece W, which is mounted on the turnover station 92 (a base) in the first state in which the first sheet surface s1 faces upward and the second sheet surface s2 faces downward and has the flexibility, such that arrangement of the first end portion w11 positioned on the first side in the predetermined turnover direction and the second end portion w12 positioned on the second side in the turnover direction is reversed, thereby bringing the workpiece W into the second state in which the first sheet surface s1 faces downward and the second sheet surface s2 faces upward. The robot 100 includes the first robot arm 1, the first end effector 3 that is coupled to the first robot arm 1 so as to rotate about the predetermined first rotation axis E1, and the controller 7 that controls the first robot arm 1 and the first end effector 3. The controller 7 turns over the workpiece W into the second state by causing the first end effector 3 to execute a holding operation of holding the first portion w21, which is the portion including the first end portion w11 when the workpiece W is divided in half in the turnover direction, of the workpiece W in the first state with the first rotation axis E1 being parallel with the first sheet surface s1 and the second sheet surface s2, causing the first robot arm 1 to execute, after the holding operation, a lifting operation of lifting the first end effector 3 such that the second sheet surface s2 separates from the turnover station 92, causing the first robot arm 1 to execute, after the lifting operation, a lowering operation of lowering the first end effector 3 with the first sheet surface s1 facing downward, and causing the first end effector 3 to execute, before completion of the lowering operation and after the holding operation, a rotary operation of rotating about the first rotation axis E1 in a direction of raising the first end portion w11.

The rotary operation is executed at least during the lowering operation

According to this configuration, the first end effector 3 rotates about the first rotation axis E1 in a direction of raising the first end portion w11 when the first robot arm 1 lifts the first end effector 3 holding the workpiece W in the lifting operation. Thus, the workpiece W can be lifted such that the second sheet surface s2 of the workpiece W stands to the angle perpendicular to or substantially perpendicular to the turnover station 92. Particularly, this is effective for the case of a workpiece W having flexibility, but being less bendable, i.e., a workpiece W having a high stiffness. Thus, a smooth transition to a lowering operation of lowering the first end effector 3 such that the first sheet surface s1 faces downward can be made. As a result, the workpiece W can be turned over by simple operation without the need for picking up the workpiece W again after the workpiece W has been temporarily put on a certain location or passing the workpiece W to another end effector.

### <<Other Embodiments>>

The embodiment has been described above as an example of the technique disclosed in the present application. However, the technique in the present disclosure is not limited to above, and is also applicable to embodiments to which changes, replacements, additions, omissions, etc. are made as necessary The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

For example, the workpiece W is not limited to the FPC As long as the workpiece W is in the sheet shape with the flexibility, any workpiece can be employed. For example, the workpiece W may be a film or paper.

The shape of the workpiece W is any shape. The workpiece W does not necessarily have at least one of the first protruding pieces w1 or the second protruding pieces w2.

The installation process by the robot 100 is not essential. The robot 100 may perform only the turnover process.

The robot 100 turns over the workpiece W in the longitudinal direction thereof, but may turn over the workpiece W in a lateral direction (i.e., the width direction) thereof.

The robot 100 is not limited to the double-arm robot. The above-described processes may be performed by two robots, each of which includes a single robot arm. Alternatively, in the case of performing only the turnover process, a single robot including a single robot arm may execute the turnover process.

It may only be required that in the turnover process, at least the holding operation, the lifting operation, the lowering operation, and the rotary operation are executed. The preliminary operation and/or the lateral movement operation may be omitted For example, in the lifting operation, the second end portion w12 moves to the first side in the turnover direction in association with lifting of the first end portion w11 of the workpiece W. When the workpiece W separates from the turnover station 92, the second end portion w12 is movable to the first side in the turnover direction by inertia. Accordingly, a state in which the first portion w21 is positioned on the second side in the turnover direction with respect to the second portion w22, i.e, a state in which the first sheet surface s1 faces downward, can be brought. In this case, only the first end effector 3 is lowered vertically downward without the preliminary operation and the lateral movement operation so that the workpiece W can be laid on the turnover station 92 with the first sheet surface s1 facing downward

Similarly, in the case of executing the rotary operation during the lifting operation, the rotary operation is executed when the workpiece W separates from the turnover station 92 so that the second end portion w12 can move to the first side in the turnover direction by inertia. Also in this case, only the first end effector 3 is lowered vertically downward without the preliminary operation and the lateral movement operation so that the workpiece W can be laid on the turnover station 92 with the first sheet surface s1 facing downward.

The rotation angle of the first end effector 3 in the rotary operation is not limited to 90 degrees. In the rotary operation, the first end effector 3 may rotate about 45 degrees from a holding state, or may rotate to about 135 degrees That is, as long as the first end effector 3 rotates in a direction of turning over the first end portion w11 such that the first sheet surface s1 faces downward, the rotation angle of the first end effector 3 may be set as necessary.

The pressing operation may be omitted. For example, in a case where movement of the workpiece W on the turnover station 92 is allowed in the release operation, the pressing operation is not necessary. In a case where, e.g., a stopper that limits movement of the workpiece W in the release operation is located at, e.g, the turnover station 92, movement of the workpiece W can be restricted even if the pressing operation is omitted.

In the turnover process of the embodiment, the rotary operation is executed during the lowering operation, but the present invention is not limited to above It may only be required that the rotary operation is executed before completion of the lowering operation and after the holding operation. For example, the rotary operation may be executed in at least one of the lifting operation or the preliminary operation. Alternatively, the rotary operation may be performed from the lifting operation to the preliminary operation or from the lifting operation to the lowering operation.

In the turnover process of the variation, the lateral movement operation is performed from the final phase of the lifting operation to the lowering operation, but the present invention is not limited to above. For example, the lateral movement operation is not necessarily performed in the lifting operation, and may be performed without lifting the first end effector 3 after the lifting operation. Alternatively, a lateral movement operation of moving the first end effector 3 in the horizontal direction may be executed between the lifting operation and the lowering operation independently of the lifting operation and the lowering operation.

In the installation process, the first end effector 3 executes the pushout operation with gripping the pushout tool 96. The pushout tool 96 may be constantly located at the first end effector 3.

Operation of the first robot arm 1 and the first end effector 3 and operation of the second robot arm 4 and the second end effector 6 may be switched from each other. For example, the lifting operation in the turnover process may be performed by the second robot arm 4.

DESCRIPTION OF REFERENCE CHARACTERS

| | |
|---|---|
| 100 | Double-Arm Robot |
| 1 | First Robot Arm |
| 3 | First End Effector |
| 4 | Second Robot Arm |
| 6 | Second End Effector |
| 92 | Turnover Station (Base) |
| 94 | Jig Plate (Jig) |
| 94 a | Opening |
| 94 b | First Edge (Engager) |
| 96 | Pushout Tool (Tool) |
| E1 | First Rotation Axis |
| E2 | Second Rotation Axis |
| s 1 | First Sheet Surface |
| s 2 | Second Sheet Surface |
| W | Workpiece |
| w 0 | Workpiece Body |
| w 1 | First Protruding Piece |
| w 2 | Second Protruding Piece |

1. A robot that turns over a sheet-shaped workpiece, which is mounted on a base in a first state in which a first sheet surface faces upward and a second sheet surface faces downward and has flexibility, such that arrangement of a first end portion positioned on a first side in a predetermined turnover direction and a second end portion positioned on a second side in the turnover direction is reversed to bring the workpiece into a second state in which the first sheet surface faces downward and the second sheet surface faces upward, the robot comprising:
a first robot arm;
a first end effector that is coupled to the first robot arm so as to rotate about a predetermined first rotation axis; and
a controller that controls the first robot arm and the first end effector,
wherein the controller turns over the workpiece into the second state by causing
the first end effector to execute a holding operation of holding a first portion, which is a portion including the first end portion when the workpiece is divided in half in the turnover direction, of the workpiece in the first state with the first rotation axis being parallel with the first sheet surface and the second sheet surface,
the first robot arm to execute, after the holding operation, a lifting operation of lifting the first end effector such that the second sheet surface separates from the base,
the first robot arm to execute, after the lifting operation, a lowering operation of lowering the first end effector with the first sheet surface facing downward, and
the first end effector to execute, before completion of the lowering operation and after the holding operation, a rotary operation of rotating about the first rotation axis in a direction of raising the first end portion.

2. The robot of claim 1, wherein
the controller causes the first robot arm to execute, during the lowering operation, a lateral movement operation of moving the first end effector to the second side in the turnover direction.

3. The robot of claim 2, wherein
the controller causes the first robot arm to execute, after the lifting operation and before the lowering operation, a preliminary operation of moving the first end effector to the first side in the turnover direction.

4. The robot of claim 1, wherein
the rotary operation is executed at least during the lowering operation.

5. The robot of claim 1, wherein
the rotary operation is executed at least during the lifting operation.

6. The robot of claim 1, wherein
in the lowering operation, the first robot arm lowers the first end effector to a predetermined position apart from the base, and
the controller causes the first end effector to execute, after the lowering operation, a release operation of releasing the held workpiece.

7. The robot of claim 1, wherein
the workpiece is in a shape extending in a predetermined longitudinal direction,
the first end portion is one end portion of the workpiece in the longitudinal direction, and
the second end portion is the other end portion of the workpiece in the longitudinal direction.

8. The robot of claim 6, further comprising:
a second robot arm; and
a second end effector that is coupled to the second robot arm,
wherein the controller
causes the second end effector to execute, before the release operation, a pressing operation of pressing a portion of the workpiece at which the first sheet surface contacts the base.

9. The robot of claim 1, further comprising:
a second robot arm; and
a second end effector that is coupled to the second robot arm so as to rotate about a predetermined second rotation axis,
wherein the workpiece has a workpiece body and a first protruding piece coupled to the workpiece body in a cantilever manner, and
the controller causes
the first robot arm and the second robot arm to execute a delivery operation of delivering the workpiece to a jig with the first end effector and the second end effector holding the turned-over workpiece in the second state,
one of the first robot arm or the second robot arm to execute a separating operation of lifting a corresponding one of the first end effector or the second end effector holding the workpiece such that the first protruding piece separates from the jig,
the other one of the first robot arm or the second robot arm to execute a pushout operation of pushing the first protruding piece by a corresponding one of the first end effector or the second end effector such that a free end of the first protruding piece protrudes downward from the workpiece body, and
the one of the first robot arm or the second robot arm to execute an insertion operation of lowering the corresponding one of the first end effector or the second end effector such that the free end of the first protruding piece is inserted into an opening located at the jig.

10. The robot of claim 9, wherein
the one of the first robot arm or the second robot arm lifts, in the separating operation, the corresponding one of the first end effector or the second end effector such that an end portion of the first protruding piece coupled to the workpiece body is positioned higher than the free end of the first protruding piece.

11. The robot of claim 10, wherein
the controller causes the end effector holding the workpiece in the separating operation to execute, before the pushout operation, a curving operation of curving the workpiece with the second sheet surface inside and the first sheet surface outside by rotating about a corresponding one of the first rotation axis or the second rotation axis.

12. The robot of claim 9, wherein
in the pushout operation, the end effector pushing the first protruding piece grips a pushout tool to push the first protruding piece by the pushout tool.

13. The robot of claim 9, wherein
the workpiece further has a second protruding piece bent from the workpiece body, and
in the delivery operation, the first robot arm and the second robot arm cause the second protruding piece to engage with an engager located at the jig.
